(19) United States
(12) Patent Application Publication
(10) Pub. No.: US 2015/0113068 A1
(43) Pub. Date: Apr. 23, 2015

(54) Barcode, sound and collision for a unified user interaction

(71) Applicant: Wesley John Boudville, Los Angeles, CA (US)

(72) Inventor: Wesley John Boudville, Perth (AU)

(73) Assignee: Wesley John Boudville, Los Angeles, CA (US)

(21) Appl. No.: 13/998,280

(22) Filed: Oct. 18, 2013

(51) Int. Cl. A63F 13/33; G06F 17/30; H04L 12/58

(52) U.S. Cl. CPC A63F 13/33; H04L 51/046; G06F 17/30879
USPC 709/205; 463/42; 235/375

(57) ABSTRACT

A user with a mobile device can send and get data from a nearby device, where the latter can be a mobile device held by another person. Both devices communicate with a central server, that gives pages to the devices, letting the devices interact. The interaction is initiated by a barcode or an audio signal or a deliberate collision between the devices. The collision uses a collision server. If the second device has a large screen, like in a shop window, the central server can send web pages to the devices. The page on the mobile device has widgets that emulate browser buttons on the large screen or keys on a keyboard. Letting the pages on the large screen be standard web pages normally shown on a typical desktop or laptop, for backward compatibility and rapid deployment.

### TECHNICAL FIELD

The invention relates to the use of two or more mobile devices for a multiuser interaction or to control a nearby screen. One of the mobile devices might be a Head Mounted Device.

### REFERENCES CITED

“Displays—Fundamentals and Applications” by R. Hainich and O. Bimber, CRC Press (2011), 978-1568814391.
“Head Mounted Displays” by J. Melzer and K. Moffitt, CreateSpace (2011), 978-1456563493.
“Googling yourself takes on a whole new meaning” by C. Thompson, New York Times, 30 Aug. 2013,
“Bump suppression” by A. Huibers, U.S. Pat. No. 8,531,414 (2013).
“Matching devices based on information communicated over an audio channel” by A. Huibers et al, US patent application 20130130714.
“Bump button” by A. Huibers et al, US patent application 20130217335.
“Bump validation” by A. Huibers, US patent application 20110191823.
“Display apparatus” by A. Machida, US patent application 20120320100.
“Wearable computer with superimposed controls and instructions for external device” by A. Wong et al, US patent application 20130069985.
“Friending codes” by S. Harris, US patent application 20120211557.
“Electronic commerce system” by P. Huster, US patent application 20130091058.
“Social networking information system and method” by L. Vastardis et al, US patent application 20130212229.

[Web references are from October 2013.]

bump.com

captcha.net

chirp.io

reconinstruments.com

spaceglasses.com

vuzix.com

### BACKGROUND

Jane and Bob are near each other. They have cellphones. They want to play a multiplayer game on their phones. The game is held on an Internet server. Suppose the game is played on phone browsers. How do they tell the server that they want to play the same instance of that game? The state of the art mostly presupposes that both users will log into the same website. One user will go to a web page (“lobby”) where he and others post that they are available for a real time game play. The other user then makes her way to the lobby page and tries to find the first user.

Often the lobby might be used by the second user simply to find any other player.

The gaming prior art has neglected the following situation of social interaction. Jane and Bob are near each other and want to play a game. Where they do not necessarily know each other. And where one of them has never been to the website in question.

The prior art assumes that users have to do any necessary manual steps to go to that lobby page. But if a user has never been to the website before, he likely has to manually type out the web address, which is error prone on a cellphone. And once at the home page, he has to navigate an unfamiliar website to find the lobby. Plus, if he wants to play a particular person, he has to know that person's nickname or handle on the website.

All these are manual steps and unnecessary cognitive load that hinders the spread of a computer game to new users.

### SUMMARY

This is a unified view of how two mobile devices, typically cellphones, can initiate a server based interaction. One method has a mobile device showing a barcode, gotten from the server. The other mobile device scans the barcode and decodes it into an URL that goes to the server. The server links the devices. Another method uses an audio signal from the first device to the second. A third method makes a collision between the devices. This uses a collision server, which acts to associate the addresses of the devices and pass both to the first server.

Another topic is when a first device is mobile and the second device is in a fixed location with a large screen. The latter might be in a shop window, and the user of the first device is a pedestrian in front of the window. The server sends web pages to both devices. The page for the mobile device has widgets that emulate keys on a keyboard or buttons in a browser, where the latter buttons are not in a web page but are part of the browser framework. For example, the widgets on the phone web page might correspond to a text input box or a tab key or a refresh button or a stop button.

The retailer can show web pages on the large screen, where the pages were designed to be normally seen on a standard desktop or laptop. It reuses those pages for the new context of display on a large screen, without a keyboard or mouse accessible to a user seeing the screen, where the keyboard and mouse would normally be directly attached to the computer connected to the screen. This gives a rapid deployment mode, without having to write a new set of paired web pages designed expressly for the mobile phone and large screen interaction.

Two users with mobile devices in front of a large screen can control it. By colliding their devices, the collision server lets them pick the screen. It sends the screen's server the addresses of the devices. The server then sends pages to the devices, to control the screen.

A Head Mounted Device (like Google Glass™) or a smartwatch can control a large digital screen, where the latter is connected to the Internet. The HMD user can send the video feed to one or more remote users, who can then see the contents of the large screen as the HMD user varies what appears on the latter. The HMD user can let the remote users also see and control the large screen. The remote users get a copy of the control page that the HMD user has on her HMD display.

A user who meets another person can invite him to join her list of ‘friends’ in a social network by encoding the necessary link and related information in an URL. She transmits this to his device via the above methods.

A site that lets users interact on their mobile devices via the site's pages can let a user define an ad hoc group of the users she interacts with. This can be used for future interactions where the users might not be initially in proximity.

### BRIEF DESCRIPTION OF THE DRAWINGS

FIG. 1 is a top level diagram of the interaction mechanisms.

FIG. 2 is an interaction between a mobile device and a nearby device.

FIG. 3 is a mobile device colliding with another device in an interaction.

FIG. 4 is a simpler description of FIG. 3.

FIG. 5 shows buttons on a mobile device page to control a screen on another computer.

FIG. 6 is another means of a collision interaction.

FIG. 7 is two users controlling a nearby screen via a collision.

FIG. 8 is an HMD controlling a screen and contacting a remote observer.

FIG. 9 is a remote machine controlling a screen via an HMD.

FIG. 10 is an HMD and a remote machine jointly controlling a screen.

FIG. 11 is two remote users controlling a screen via an HMD.

FIG. 12 is a user sending her contact information to a nearby user.

FIG. 13 is a user joining another user's group after a meaningful interaction.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Barcode and cellphone for privacy and anonymity”, filed 4 Oct. 2011, US application 20130086465 [“3”]; “Colour barcodes and cellphone”, filed 16 Dec. 2011, 20130157760 [“4”]; “Mobile device audio from an external video display using a barcode”, filed 25 May 2012, Ser. No. 13/506,921 [“5”]; “Dynamic group purchases using barcodes”, filed 29 May 2012, Ser. No. 13/506,957 [“6”]; “Chirp to control devices”, filed 9 Oct. 2012, Ser. No. 13/573,823 [“7”]; “Barcode to enhance mobile multiplayer games”, filed 22 May 2013, Ser. No. 13/986,650 [“8”].

Here, when we refer to a mobile device, this typically can be a cellphone. And specifically, it can be a type of cellphone currently termed a “smartphone”. The distinguishing aspects of a smartphone, as compared to a cellphone that is not a smartphone, is that the smartphone has a screen and Internet access, and lacks a physical keyboard. In terms of technological trends and of the usage of the word ‘cellphone’, we suggest that these aspects might eventually be folded into typical properties of a cellphone. Other types of mobile devices that could be used in this submission might be tablets, notebooks, netbooks, electronic book readers, PDAs, Head Mounted Devices (HMDs) or digital cameras.

We will describe the use of 2 dimensional barcodes. Examples of these include QR and Data Matrix codes. But other types are possible, including 1 and 3 dimensional formats.

The submission has the following sections.

1: Top level

2: Mechanisms

3: Use cases

4: Extensions

4.1: All means

4.2: Geofencing

4.3: Self construction of URL

4.4: Collaborative Workspace

4.5: Two users controlling an external screen

4.6: Dynamic group purchases and large screen

4.7: Head Mounted Device and Smartwatch

4.8: Joining an existing social network

4.9: Ad hoc social network

1: Top Level

The main idea of this submission is how a user with a mobile device can send and get data in a wireless manner to another electronic device that is nearby, to affect or control the other device. And likewise, how that other device might similarly affect the first device. The meaning of nearby will vary with the mode of interaction. The second device could be another mobile device held or worn by a user. Or it might be an electronic screen with its controlling computer, where the screen is in a fixed location, at least temporarily.

Another key idea is that the mechanisms of interaction largely use the default hardware typically understood to be part of the devices. Specifically, when the mobile device is a cellphone, the mechanisms involve the cellphone having default hardware common in recent years in the developed countries, and not needing a special hardware attachment. This is important. It maximises the potential user hardware base for implementations of the submission. Largely then, the practical result is that the implementations of this submission can be mostly performed by software and by manual steps done by the users of the devices. The software could be and in general will be located on the devices and on servers located on a computer network. Typically, the latter will be the Internet.

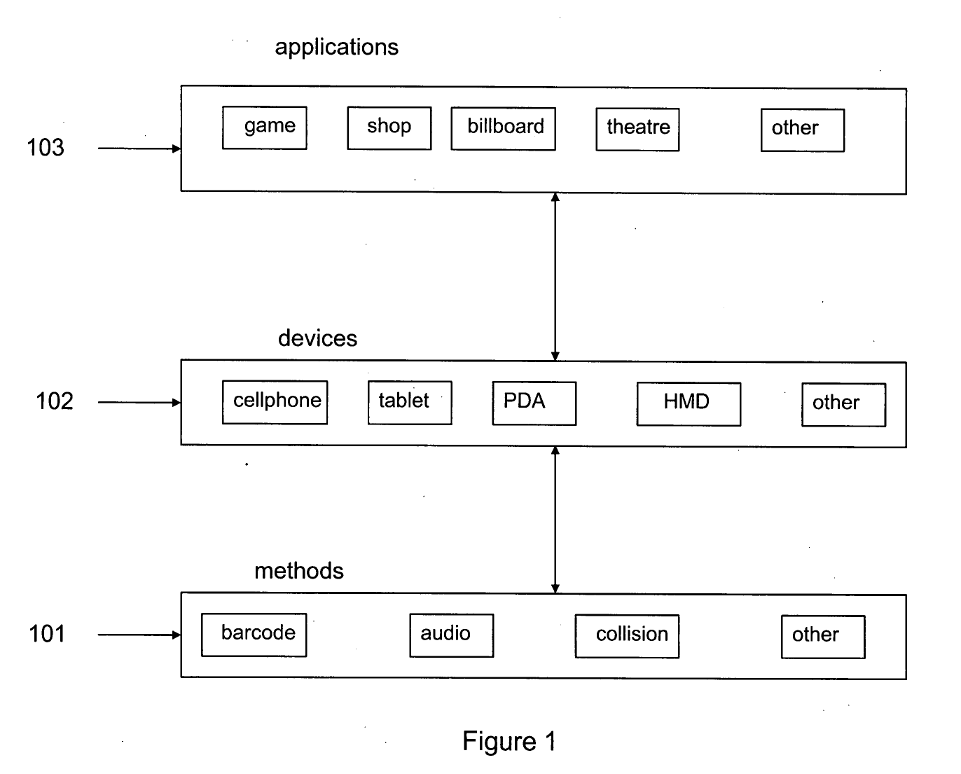

FIG. 1 is a top level diagram of this submission. Item 101 is a collection of interaction methods used by devices 102. These are applied to the applications 103. For clarity, we did not put numeric labels on the items inside each of 101, 102 and 103.

The methods 101 are the use of barcode, audio, collisions and other means. The use of barcodes was described in our earlier submissions “1”-“7”. The use of audio was described in submission “7”.

For devices 102, we mean an interaction between 2 devices, where at least one device, which we call the first device, is one of the mobile items in 102. The second device might also be an item in 102. Or it might be a computer and a screen, both in a fixed location near the first device. Note that if the second device is in 102, it might be of the same type as the first device. The most important case is when both devices are cellphones.

For applications 103, we described the use of shop window and electronic billboard in submission “1”. We described the use of movie theatre in submission “6”. We described the use of game in submission “8”.

For simplicity in FIG. 1, the game instance in applications 103 should not be considered mutually exclusive from the other types shown in 103. There might be a game playable on an electronic billboard or on an electronic screen in a shop window, for example.

Note that not necessarily every combination of items in 101, 102 and 103 is desirable to be implemented or is even possible.

2: Methods

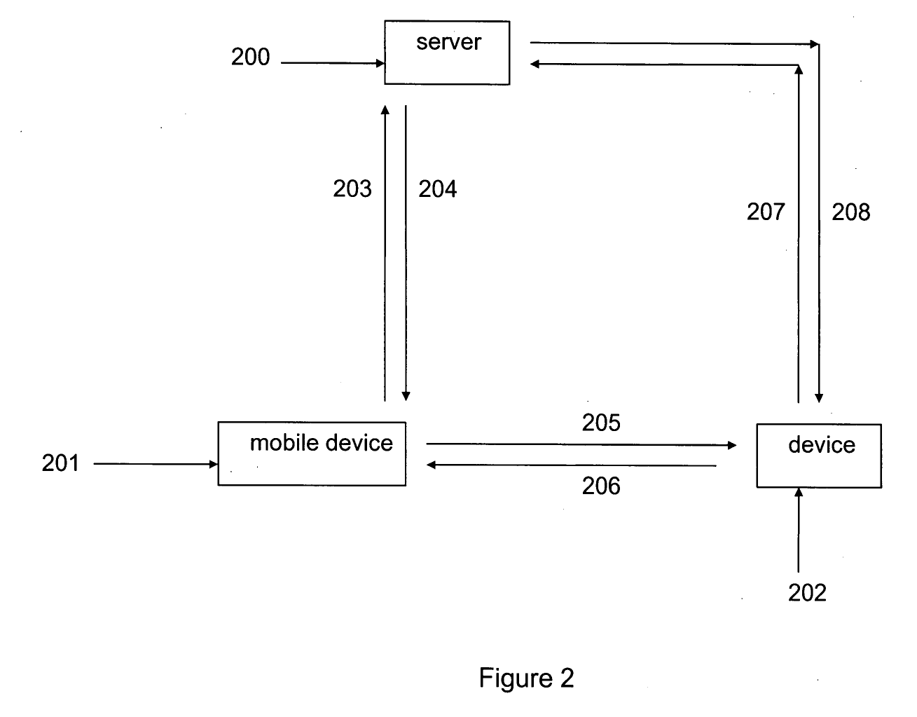

FIG. 2 is a summary of the steps common to methods 101. Device 201 is a mobile device. The user of 201 wants to interact with or control in some manner item 202. Item 202 could be another mobile device, held or worn by another user. Or depending on circumstances, it might be a large electronic screen with a controlling computer, for example.

Item 200 is a server on a computer network; typically the Internet. It is assumed that devices 201 and 202 typically have the ability to do a bidirectional interaction with server 200. Thus device 201 has a network address, Alpha, and device 202 has a network address, Beta. Device 201 sends a wireless request 203 to server 200. It replies with 204, which is typically an URL, where the URL encodes an identifier of Alpha.

Device 201 then converts 204 to a form 205 and conveys 205 in some manner to device 202. In some cases, the data in 204 and 205 might be identical. In others, 201 could apply a transformation to 204 to produce 205.

When 205 is expressed as a barcode and displayed on a screen of 201, to be scanned by a user using a camera on device 202, this was described in submission “1”. When 205 is audio, and device 202 uses a microphone to capture it, this was described in submission “7”. The reader can consult those references for more details.

We will consider below when 205 is a collision. Meanwhile, for the barcode and audio instances, signal 206 would typically not exist. So the direct interaction between the devices is a unidirectional flow of data. While a subsequent bidirectional interaction is done via server 200.

Device 202 takes signal 205 and decodes it, to the maximum extent that it can. It gets signal 207, which it sends to server 200. If device 202 is a mobile device, then the sending of signal 207 would typically be done in a wireless manner.

Server 200 now has gotten back the URL that it originally generated for device 201. In the sending of signal 207 from device 202 to the server, the server inherently knows the network address of 202, by the fundamental workings of the Internet Protocol. From signal 207, it has an association with device 201. Hence the server can now send signals to both devices. These can be considered to be in the directions indicated by 204 and 208.

One instantiation of the signals is as web pages. Which are then shown on the screens of 201 and 202. Device 201 is assumed to be controlled manually by a user. By picking various selectable items on the pages of her device, she causes new pages to be shown on her device and on 202. If 202 is also controlled by a user, then that user can do likewise, and affect the pages on 201. Hence, as discussed in “8”, a game could be played between the users.

One key variant on the above is where device 202 is a screen and its controlling computer, both in a fixed location. The overall interaction would start when device 202 communicates with server 200 via signals 207 and 208 to get a signal which it displays (like a barcode) or transmits (like sound) as signal 206. Device 201 then captures this signal. Here there is no return signal 205. Device 201 then decodes the signal and interacts with server 200 via signals 203 and 204. This was described in “1” for the barcode.

Now consider when 205 is implemented as a collision. As a physical contact between devices 201 and 202. Increasingly, phones are equipped with accelerometers that measure the acceleration in three dimensions. Also, a phone is likely to have geolocation ability, perhaps using the US GPS system. Or by other means, like using the identifications of the cellphone basestations to which the phones connect to the cellular network.

Bump Corp. implemented the following system. Two devices (usually phones) install a Bump application. Ideally this was done at earlier times by the users, and in general, separately from each other. The users come into proximity and want to exchange data between the phones. Each user starts the application on her device and picks data to send to the other person. Each device uploads to server 200 its coordinates plus the data to be exported.

The users physically “bump” or touch their devices together. Each device measures the acceleration it gets. Here, 205 is the acceleration experienced by 202, while 206 is the equal and opposite acceleration experienced by 201 (under Newton's Second Law of motion). Though note that under the vagaries of real world implementations of the accelerometers, 205 and 206 might be different in magnitudes along one or more directions of a three dimensional axis system.

The server then tries to link the addresses of the 2 phones. It looks for where the phones are as close as possible, from the locations, and where it has gotten accelerations that are as near in time as possible. And perhaps preferably with similar magnitudes. This narrows the list of possible phones down to 2, ideally. In this submission, in our extension of the Bump method, we assume that this is done correctly. The uploaded data is then transferred between the phones, via the server.

The previous 3 paragraphs summarised how a collision is used in the state of the art. It was for a general transfer of data between the 2 devices. Note that often it is for a once only transfer of data. And that the data from each phone passes through the server.

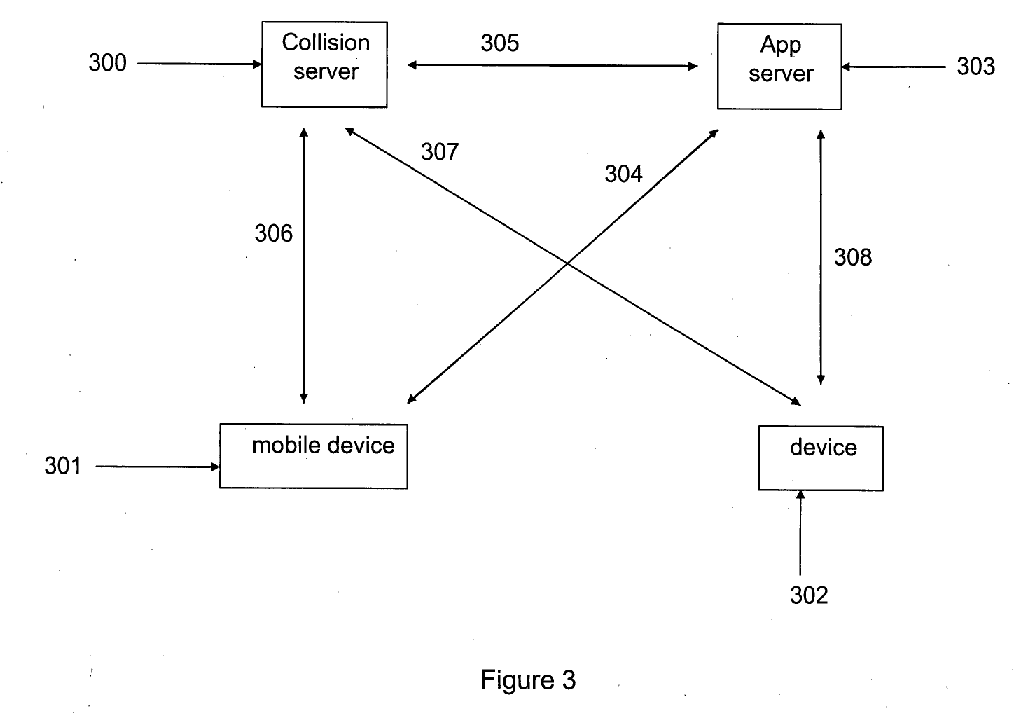

Now consider the situation in FIG. 3. The users of mobile device 301 and device 302 want to have an ongoing interaction mediated by an app server 303 on the Internet. Assume that the app server is a web server. This is the starting scenario for when the initiation mechanism was a barcode or audio, as discussed earlier where there was no collision server.

Note in passing that we use the term “collision server” in the literal sense of a computational machine (a server) that acts to find the addresses of 2 other machines that physically collide, where this process involves the broad steps described above. In the literature, and perhaps including some submissions to the US PTO, a “collision server” can refer to when two data entities with different content are hashed, and they produce the same hash. In the theory of hashing, this is called a collision. Hence “collision” has two meanings in the technical literature. We use the more literal meaning and the reader should disambiguate this from the other meaning.

One use case is where Jane, the user of device 301, might have already done the interaction with server 303 at some earlier time, with other users. So she has an appropriate URL of a web page at server 303 recorded (bookmarked) on her device. Whereas Bob, the user of device 302, might have never interacted with server 303 before. For him to go explicitly to server 303 on his device would likely need a manual typing of an address.

Device 301 loads a page from server 303 via the wireless means 304. This page has an option to connect device 301 with another device, as yet unknown to the server, in a multiuser application served by the server. The basic problem is—how does server 303 find the address of Bob's device? And how can this be done in as easy a manner as possible for Jane and Bob?

Jane picks that option on her web page. Server 303 gets this choice via 304. It makes an URL with an identifier of device 301. Note that Jane does not need to be told the details of this, to simplify her experience.

There are at least 3 ways to make the URL. Suppose device 301 has the Internet address 10.20.30.40. One way is to encode the fields of the address as an imaginary subdomain. Suppose the server has the domain “somewhere.com”. The server could make the domain 10-20-30-40.somewhere.com. Or the domain 10.20.30.40.somewhere.com. The company owning the server does not need to specifically register the latter domain with the DNS registries. Instead, it owns the machine that gets DNS queries about any *.somewhere.com, where the asterisk means any combination of subdomains.

Another way is to encode the fields as part of the right hand side of the URL, after the domain name. Like “i=10-20-30-40”, where the “i” is the symbol chosen for this argument of the URL. Because the URL could in general have other arguments.

The previous 2 ways assumed IPv4. If IPv6 is used, similar remarks would apply.

Another way is for the server to generate a random alphanumeric string, like “i38de0”. The server has an internal table, that maps from this string to the actual address of device 301. It puts the string as a subdomain, like i38de0.somewhere.com. Or as an argument on the right of the URL, like “k=i38de0”. In this case, the address of device 301 is never made public in the URL.

There could be other ways, possibly more intricate.

The above was just for the 2 users to connect their devices in a multiplayer application. We now refer to submission “8”, which looked at different ways to have multiplayer involvement in games. The above corresponds to the case of the first player wanting to play a game with the second player. This can be considered the simplest, default case.

Submission “8” also had the case of adding a watcher or observer. Here, when Jane used Device 301 to go to the app server website, she could pick an option from a menu of choices. One choice was the earlier default of adding a player. The next choice could be to add a watcher. This causes the web site to add an extra field to the URL to the right of the domain name, say “h=2”, where “h” is the name of the menu, and the value “2” might mean add a watcher.

Another choice in submission “8” was hand off, where Jane wants to leave an ongoing game, and another person nearby wants to take her place in the game. So the URL might say in part “h=3”, where “3” means hand off. Another choice in “8” was add a helper or assistant. This could now be represented by “h=4” in the URL.

Clearly, more choices could be represented in this manner. Also, all this assumed only one menu of choices. If there were more menus of choices, each menu could be assigned a different field. So another menu might be mapped to a field “r=”, where “r” is the label of the field and where the choice from the menu would be on the right side of the equals sign.

Server 303 sends, via signal 305, the URL (however it is constructed above) to the collision server 300 and it might also send the address of device 301. In some instances where the latter address is encoded explicitly in the URL, then server 300 might already know the encoding algorithm, so the address need not be sent to it. Or suppose there are different instances of server 303, at different independent domains, and these choose different encodings. There could be a standard index of each explicit encoding method, and this index could be passed from a given server 303 to the collision server, along with the URL.

The sending of data from server 303 to the collision server could be by any electronic means 305, wired or wireless. Though it is expected that both servers will be wired to the network. In general, the sending need not be via a Web protocol like http or https, but could be by any method allowed by that network.

When the collision server 303 successfully gets the signal 305, it might respond with a ‘success’ signal along channel 305.

Server 303 sends a signal by wireless means 304 to mobile device 301, telling Jane to collide her device with the other device. This could be done by updating her page with the necessary text and an optional audio component, or by sending a new page. Or by sending a control to vibrate 301, if that is possible. Or by causing a flashing light on 301, if possible.

A variant on the previous paragraph is where the collision server can initiate a communication via signal 306 to Jane's device, telling her to collide her device with the still unknown. (to both servers) device 302.

In either case, Jane tells Bob to collide their devices. They start, or perhaps they have already started, any necessary client software of the collision server on their devices. They collide their devices. Collision data is uploaded via 306 and 307 to the collision server.

It associates the addresses of devices 301 and 302, as in the prior art. It sends the URL to device 302. Bob either manually runs the URL in a browser on device 302, or software on device 302 automatically brings up a browser and loads it with that URL. (The latter is preferred.) That software could be part of any client software of the collision server already installed on device 302. Or it could be extra software, that perhaps analyses any data downloaded from the collision server via signal 307. And, if the data is in the format of an URL, the software starts a browser with that URL.

In either case, device 302 makes an URL query to server 303. The server can associate devices 301 and 302. Because from the parsing of the URL, the server finds the address of device 301. Similar to what was done earlier for the barcode and audio interactions. It sends appropriate pages to the devices, to start a multiuser interaction.

When the collision server can associate the addresses of 301 and 302, it can send 302's address to server 303 via channel 305. This address can be a check against server 303 subsequently getting the URL from device 302, with 302 then querying server 303 from 302's address. If the addresses do not agree, server 303 might not reply to the query from device 302, and it might send some type of error message to device 301.

Unlike the state of the art use of a collision server, this submission does not have either user explicitly designate data that is sent to the other user's device. By removing this manual step for both users, it simplifies and can make more robust the user interaction.

Another difference is that the data that the collision server gets is essentially just the network addresses, geolocations and accelerations of the devices. Other data inside each device never goes through the collision server. This can be useful. Where there is a general purpose collision server, and many application servers 303. Some of the latter servers or some users of devices 301 and 302 could be reluctant to pass sensitive data to a relatively untrusted or insecure collision server.

One variant is where when Jane picks the option to tell server 303 to make the URL, that the server is able, perhaps via contacting or controlling her browser, to tell her device to start any client collision software. Or to install such software if it does not already exist on her device, or to offer her the option of allowing such an installation.

Stepping back from the above discussion we have the following. The manual steps needed to be done by Jane and Bob are minimised. Especially for Bob. He just has to start any local collision software and to touch his device against Jane's. He has no typing to do.

This is a big advantage. Imagine Jane and Bob wanting to run a joint application, where Bob has never done this before. If he has to type the URL of server 303 and then navigate within that domain's pages, to find an appropriate page where he and Jane can have their interaction, this is error prone. In submission “8” we discussed this for the interaction mechanism of a barcode or audio. The advantages in the current submission are similar for our collision interaction.

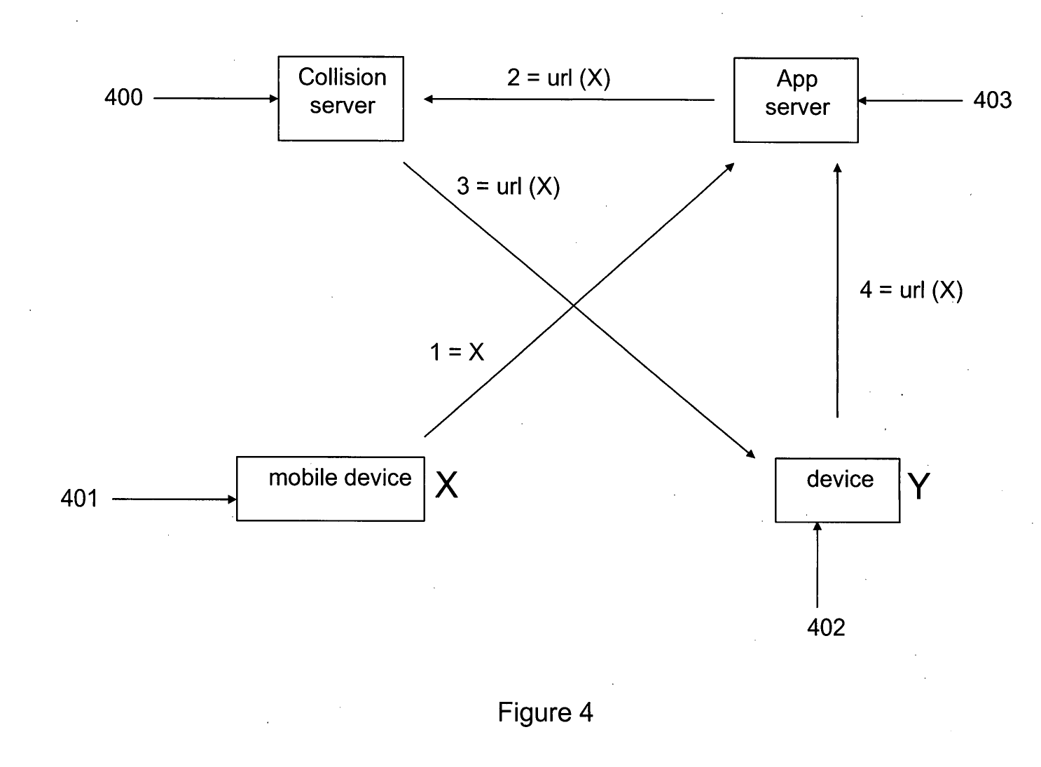

FIG. 4 is a modification of FIG. 3, redrawn to hopefully make some steps easier to follow. Mobile device 401 is mobile device 301, device 402 is device 302, app server 403 is app server 303 and collision server 400 is collision server 300. Next to mobile device 401 is the label “X”. This is the address of device 401. Next to device 402 is the label “Y”. This is the address of device 402.

There is an arrow from mobile device 401 to app server 403, with the label “1=X”. This means that Step 1 consists of address X being uploaded to the app server. There is an arrow from app server 403 to collision server 400, with the label “2=url (X)”. This means that Step 2 is the app server making an URL from X and sending the URL to the collision server.

There is an arrow from collision server 400 to device 402, with the label “3=url (X)”. This means that Step 3 is the collision server downloading the URL to device 402, after the collision.

There is an arrow from device 402 to app server 403, with the label “4=url (X)”. This means that Step 4 is device 402 transmitting the URL to the app server, which then associates the addresses X and Y. Because the app server can map from url (X) to X, and the query from device 402 tells the app server Y, from the lowest level property of the Internet.

FIG. 4 deliberately suppresses the explicit showing of the collision between the mobile device and device 402, and also the uploading of the addresses of these devices to the collision server. These occur in time between the Steps 2 and 3. In part, these are suppressed because they are steps of the prior art. FIG. 4 focuses on the steps unique to this submission. It is hoped that the reader can easily follow the logic of the data flow of the device addresses.

Note that here, as in submission “8”, Jane and Bob are not symmetric in their roles. Jane is assumed to have successfully interacted with server 303 in the past. So in the current interaction, she can easily and robustly (i.e. with minimum chance of error) go to the appropriate page of server 303. Perhaps via having bookmarked that from an earlier interaction.

Nor do we assume that Jane and Bob know each other. So they do not know each other's electronic address, like their email addresses. And they are not in each other's buddy list or friend's list on some social network or mail server. Suppose they want to do an alternative to the steps above, to jointly run an interaction. One way might be for Jane to email Bob a link to a page at server 303, where he can interact with her. But this requires her to type accurately his email address, since he is not in her buddy list. Brittle and error prone on a mobile device that would have a small keyboard (real or virtual).

In FIG. 1, item 101 depicted a fourth case, “other”. This could involve a direct transfer of data from 201 to 202. One case is where Near Field Communication (NFC) is used. 201 has an NFC transmitter and 202 has an NFC receiver. Or perhaps both devices have transceivers for other wireless means, like RFID, Bluetooth or ZigBee.

These can be used similarly to how audio was used to communicate between devices 201 and 202. Device 201 gets an URL from server 200 and transmits it wirelessly to 202. Device 202 sends the URL as signal 207 back to server 200. Which can now link 201 and 202.

This is deliberately used here as an alternative to what is the simpler hardware configuration. If 201 and 202 can directly communicate with each other, why use server 200?

One reason is that devices 201 and 202 might wander out of direct communication range. Another is that server 200 might have a content rich application that both users can play or jointly use (if the application is not a game). For example, 201 is already assumed to be a mobile device. If 202 is also a mobile device, then both likely have fewer resources (like memory or disk) than a server device.

3: Use Cases

3.1: Games

Consider where users want to play games on their mobile devices. In “8”, we discussed this for the mechanisms of the barcode and audio. In the current submission, we discuss this for the mechanism of collision.

3.2: Non-Games

Consider when device 202 is a screen (with its attendant controlling computer) in a shop window, or an electronic billboard, as discussed in submission “1”. Jane, the owner of mobile device 201, uses it to control screen 202.

From the perspective of the server, it serves up paired data. One member of each pair is a web page customised for the small screen of device 201. While the other member is an image, usually much larger, to be shown in screen 202. Specifically, if screen 202 is showing web pages, then we have pairs of web pages, one small and one large.

We produced two prototypes that reduced submission “1” to practice. But we found that the customising could be labour intensive in programming. Consider the standpoint of a national retailer, with many physical stores in which the screens would be deployed. It would likely have a data center and Information Technology staff to do this coding. So such a large retailer might find it more cost effective to implement the submission than a small retailer.

An alternative is for a different choice of web pages. The small pages, for the mobile device, could have clickable buttons (links) that emulate, in part, a subset of keys on a physical keyboard.

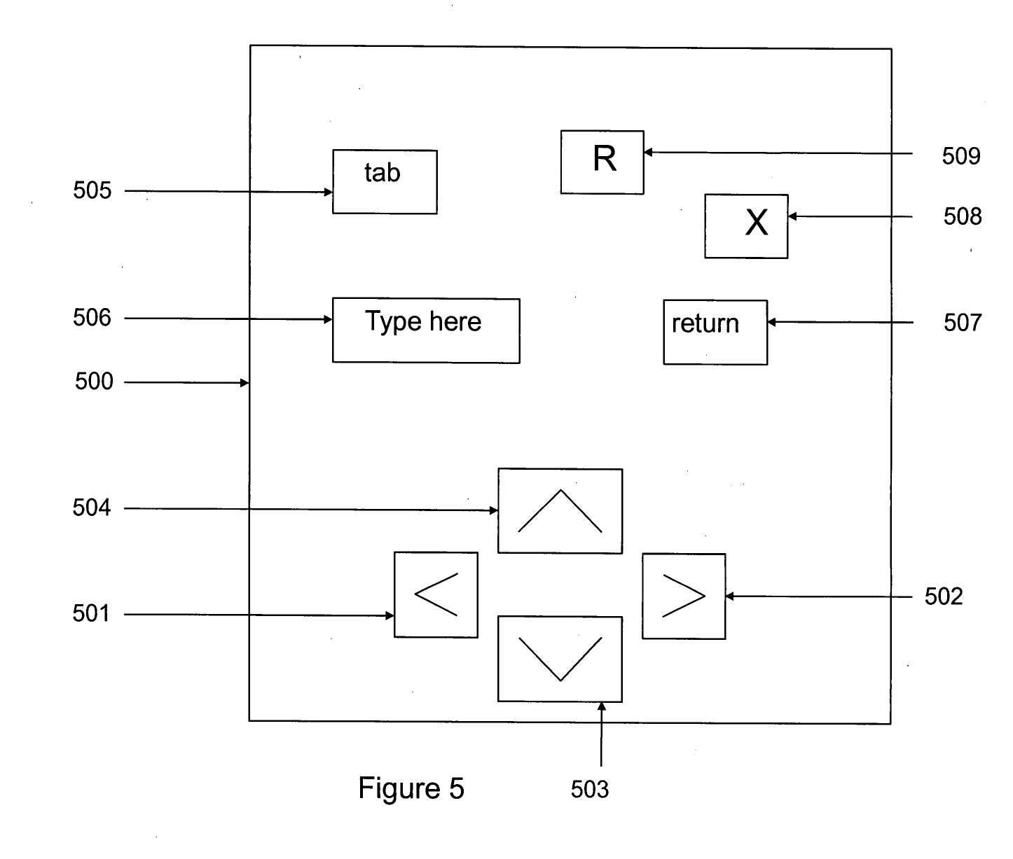

See FIG. 5. It shows a web page 500 on mobile device 201. The aim is to show a generic web page from the retailers, on a large screen 202. The web page has been customised for a typical desktop or laptop screen. We want software buttons on the page on device 201 to control the display on screen 202. Because the user cannot directly access any input peripheral (i.e. keyboard and mouse) of screen 202.

Button 501 scrolls left. Button 502 scrolls right. Button 503 scrolls down. Button 504 scrolls up. Each applies to screen 202. Collectively they emulate horizontal and vertical slider bars on screen 202 and the appropriate buttons on a physical keyboard attached to the computer for screen 202, that let the user of the keyboard move the sliders, without using a mouse.

Button 505 tabs through the selectable items on the web page on screen 202. It emulates a hardware tab button on a keyboard attached to the computer for screen 202.

Text widget 506 is a text input area. Text written here by Jane will be inserted into a corresponding text input widget on screen 202, if the current focus on screen 202 is on such a widget.

Button 507 emulates the return key for screen 202.

Button 508 emulates the “stop loading” button on a browser. Pressing button 508 stops the loading of the contents on screen 202.

Button 509 emulates the reload button on a browser. Pressing button 509 reloads the contents on screen 202. This can be implemented to have the effect of erasing any text input that the user has typed using widget 506 into various text input areas of screen 202.

Obviously in FIG. 5, the arrangement of the widgets is arbitrary. Also, any given implementation of FIG. 5 might omit some of these widgets. And optionally have other widgets. For example, there might be buttons that emulate the back and forward buttons of a browser. Where pressing the ‘back’ button acts to show the last displayed ‘page’ on screen 202. And pressing the ‘forward’ button acts, if possible, to show the next displayed ‘page’ on screen 202. Here, as with the standard forward button on a browser, the ‘forward’ button only can take effect if the user has previously pressed the ‘back’ button, so that a ‘forward’ page is now a well defined entity in the memory of the computer controlling screen 202.

We should make absolutely clear here the difference and the similarity between the buttons in FIG. 5 and the corresponding widgets of a normal browser. Largely, the latter widgets are not part of a web page, but are intrinsically part of the browser frame, external to any web page. In FIG. 5, the widgets are shown in a conventional web page that appears in a conventional phone browser. The latter likely has the regular buttons in its framework that correspond to the buttons of FIG. 5. But we need the buttons of FIG. 5 because these act on screen 202. The user of mobile device 500 does not have access to the input peripherals of screen 202 (i.e. a keyboard or mouse).

It may be that some of the buttons of FIG. 5, or more precisely the functionality ascribed to them, might not be doable for a given web server that is the server for the web page in FIG. 5, and which is also the server for screen 202. It depends on the type of browser or display software in screen 202, and whether the browser or display software can accept remote signals from the web server that emulate local keys or mouse clicks.

In this case, an implementation of this section of the submission may of necessity be confined to implementing whatever buttons are possible for that combination of server and screen 202.

Collectively, the widgets of FIG. 5 let the retailer quickly and easily repurpose existing web pages, that were originally written for the desktop or laptop, for a large shop window screen. Those web pages can be shown unchanged. This might be not as optimal from a graphics design perspective for the latter screen. But it gives backward compatibility and rapid deployment.

There are extensions of the above.

One is where the web server, or rather the retailer running it, confines the user to the server's domain. Note that the user cannot or should not be able to arbitrarily get access to the URL address bar of the browser on the big screen. Typically, the screen is in a shop window of a store run by the retailer. Hence it will likely want a pedestrian to remain at the retailer's website. Also, due to the public visibility of the screen, the retailer will want to prevent the user from going to, say, a pornography website.

Similarly, suppose the web page on the big screen has links to domains not run by the retailer. The server may act so when the user tries to pick such a link, it is not possible. The easiest way is that the server checks the domain in the link. If the domain is not in an approved list (‘whitelist’), which by default might just be domains owned by the retailer, then the link is not selectable.

But how does the server know that a query comes from a user in front of a shop screen, rather than a user looking at the page from her home computer?

The server can keep a record of when the original URL was produced by the server for display or use by one of the interaction mechanisms of this submission. For example, suppose the URL was to be encoded in a barcode, and especially if the server actually made the barcode image. Then the server puts an argument into the URL that designates this.

Or, refer back to when we described various ways that the server could put an identifier of the shop screen into the URL.

In any of the cases in the previous 2 paragraphs, the server can record the address of the user device that decoded the URL and sent it to the server. So it knows later when requests from that address need to be treated in the manner of this section.

We described the server as serving a web page to the mobile device, with the contents of FIG. 5. Clearly, the mobile device might have a locally installed application, that displays graphical widgets in a window, that are functionally equivalent to the web widgets of FIG. 5. Rather than showing FIG. 5 in a phone browser page. These are considered equivalent approaches in this submission. It is likely that an average user will not know or care about any minor differences.

Here, the server would respond to the user picking the widgets in the app in the same manner as though they were widgets in a web page. The updating of the app window in response to the user's choices, and to any downloading of data to it from the server, can mimic a browser.

4: Extensions

4.1: All Means

The earlier sections described several means of users with mobile devices to jointly enter a multiuser application. One extension is that an application could implement any subset of these means, or all means. This maximises the ability for users to run the application.

4.2: Geofencing

In section 2 we explained FIG. 3 and the combined use of a collision server and an app server. Geofencing could be used by the app server. This is a restriction of the interactions between the client mobile devices to be inside or outside some geographic region. And of course there could be several such regions.

When mobile device 301 makes the initial contact with server 303, via signal 304, the server might have some geographic information about device 301, via the network address of 301. But this can be very imprecise. For example, suppose the network is the Internet. Device 301 might get its Internet access and a temporary Internet address allocated to it from its cellular provider. That provider could have a set of such addresses. But the mapping from one of these addresses to a location might be to an office of the provider. Where this mapping is made available publicly. This location could be just somewhere in the city that the user of device 301 is in.

In contrast, the collision server 300, by the inherent nature of its operation, can be assumed to often have access to the actual locations of colliding mobile devices. People who want to use the collision server typically give permission for their devices to upload their locations to the collision server.

When server 303 sends an URL via signal 305 to the collision server 300, where the URL encodes an identifier of device 301, the signal can include one or more geofences. Each geofence having an indicator of whether the collision can be inside or outside the enclosed region.

If these regions are stable over time, server 303 might send these as a standalone message via signal 305 to the collision server. The latter stores these and applies them to later collisions associated with server 303.

This application of geofencing by the collision server can be a value added service offered by it. An extra revenue source. For example, if the application is for mobile gaming or gambling, the popularity of enabling those via a collision might allow the imposition of a fee.

4.3: Self Construction of URL

Section 2 described how server 303 uses the address of device 301 to make an URL that encodes the address. The URL goes to the collision server and thence, after collision, to device 302.

A variant is for Jane's device 301 to make the URL itself. It uses a format made public by server 303. Here, the fields of device 301's address are written into the URL in such a way that when server 303 gets this URL, it can extract device 301's address.

The interaction starts with Jane's device 301 making the URL. After the collision, it and other information (like the location of her device) are uploaded to the collision server via signal 306. Or perhaps the URL is sent prior to the collision.

Before or after the collision, Jane uses device 301 to go to an appropriate page on server 303. Her device browser waits here, to commence a joint interaction with Bob's device 302.

In the normal operation of the collision server, the URL is sent via signal 307 to device 302. Bob either manually loads the URL into his browser, or existing software on his device detects that the data is an URL and automatically loads his browser.

Server 303 deconstructs the URL to get device 301's address. Of course, it inherently had device 302's address from the query from that device. It looks for a recent query from 301's address. Or if none, it might want for some time for an incoming query from that address.

In either case, if such a query exists, it updates the page on device 301 and begins a joint interaction between the users' devices.

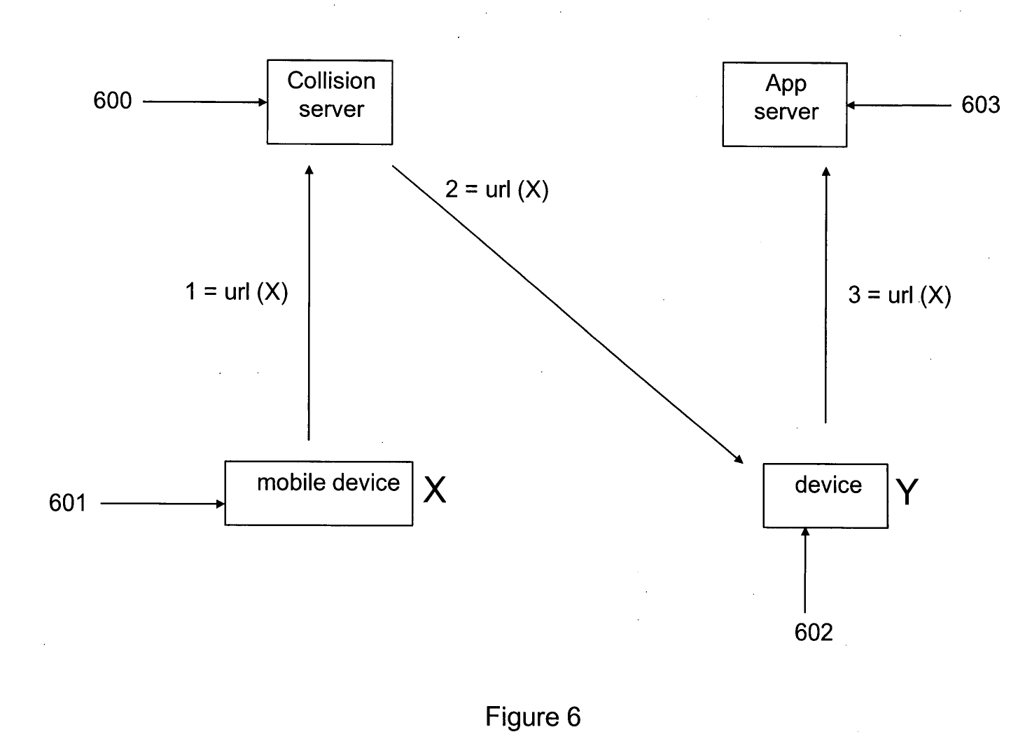

FIG. 6 shows this. It is similar to FIG. 4. Mobile device 601 corresponds to mobile device 401. Device 602 corresponds to device 402. App server 603 corresponds to app server 403. Collision server 600 corresponds to collision server 400. X is the address of mobile device 601. Y is the address of device 602.

Mobile device 601 makes URL(X) of its address X. The arrow from mobile device 601 to collision server 600 has the label “1=url (X)”, which means that in Step 1, the URL of X is uploaded to the collision server.

After the collision, the Step 2 is the arrow from the collision server to device 602, with the label “2=url (X)”. This means the URL is downloaded to device 602.

Step 3 is device 602 making the URL query to app sever 603, sending it the url(X). The app server can then decode the URL to get X. While it finds Y from the low level property of the Internet.

4.4: Collaborative Workspace

This submission and submission “8” discussed multiplayer games. Another use is for collaborative workspaces. Typically, this is equivalent to several users working on an electronic whiteboard. Where each user's device has a screen where the user can see the whiteboard and make changes to it. Most often, the devices are laptops or desktops. Here, there might be no separate physical electronic whiteboard.

In this submission, one or more of the devices might be mobile devices, like cellphones. Depending on the application, the screen on a cellphone might be sufficient for the user to participate meaningfully in the collaboration. A user can be recruited by the use of a barcode, audio or collision as described earlier.

Here is another simple use case. Possibly the most common and simple. Imagine Jane is using her device browser to look at some web page. Bob is nearby with his device, and he wants to see the same page. The prior art is if Jane's browser has some modification that lets it make a barcode encoding the URL of the page. Bob scans it and then gets that page. There is no programmatic feedback between the phones.

Now imagine that the site that Jane is looking at wants to incentivise her to publicise it and her viewing of its pages as much as possible. To encourage others to also see those pages. So she might have an account on it. She logs in and starts viewing the site's pages. When she asks the site for a barcode of the current page, the URL has an identifier of her account. If Bob then decodes the barcode and gets a copy of the page, the site increments a counter in Jane's account. This is a credit. If she increases it to some level, say, there might be some renumeration or other benefit to her.

The increment and possible associated display of the current value on her page is the programmatic feedback. Note one small different with earlier in this submission. Now, the incremented value need not be immediately shown on her device. She might have to do some affirmative action, like click on some option on the page, to see the new value. Or the site might periodically update her device with the current value of the counter. Nonetheless, the reader can appreciate that this is still a programmatic feedback.

Many elaborations are possible. One is that this counter in Jane's account increases by some amount greater than one. The amount could vary depending on the duration of time and the number of pages of the site that Bob visits, for example. So the more time (“stickiness”) he spends on the site, the greater the eventual amount credited to Jane's account.

The amount could depend on whether Bob makes an account on the site, if he does not already have one. Jane might get more credit for enabling a new user than if Bob is already a user.

While if Bob picks options on the site that give it more information about him, or if Bob buys something on the site, then Jane's counter might be incremented by some larger value.

The site might have anti-spoofing mechanisms, to try to prevent Jane from fraudulently signing up fake or redundant users. For example, it might cap the maximum amount that Jane can accrue in a given time interval. It might also keep a record of unique network addresses or other properties of Bob's device that it might consider to be an approximate unique combination.

At a simple level, when Bob gets the URL from Jane, they might engage in a “co-watching” collaboration. For example, if Bob picks a button or link in his page, which might be the same page that Jane has on her device, the site might automatically also implement the effect of this choice on her device. Or it might show a popup on her device that tells her what Bob picked and asks if she wants to do likewise. Or instead of using a popup, the site might alter her page in some manner, to show which button or link Bob picked. As an aid to her manually picking that.

The steps of this section go beyond the section of submission “8” that described an “add watcher” mechanism. The latter was where Jane, say, uses the barcode to let Bob watch her play a game on her device. He gets a screen that is what she sees on her device. But he cannot change anything. Purely read only. In the current section, he can take a more active role, and Jane is not playing a game, in general.

This could also extend to when Bob filled in a text input widget on his page and pressed return. Though a key exception could be when Bob is entering text into a password widget.

The site might let Bob and Jane diverge to seeing different pages from the site on their devices. But because the site can now associate the addresses of their devices, it might have an option that each can choose, to synchronise their device to showing what the other device is seeing.

All this reduces the need for Bob to scan the barcode from Jane's device to only once. At least for this extended encounter.

Suppose Bob ends this interaction with Jane by using his device to go to other pages from other sites. The site could keep a record of Bob and Jane's interaction. So that within some overall time limit, if Bob returns to the site and the site can detect this, then it could ask him if he would like to see whatever was the last page Jane visited on the site, if Jane is no longer at the site. Or if she is, then the current page she is seeing.

Such actions could be qualified by the site asking Jane whether to supply such information to Bob. This might be done each time Bob does this. Or Jane might have a default policy, so that she does not have to be continually asked.

In the above, where Bob asks about Jane's activity, Jane might also have the same right with regard to asking about Bob's activity.

When Bob and Jane are both looking at the site's pages (and these could be the same or different pages), the site might let each comment to the other. Via a text box for typing, or perhaps by speaking into the device. Assuming that the device has a microphone and that the other person's device has a speaker.

While the methods of the previous paragraph might seem redundant because Bob and Jane were near each other, there is no requirement in this submission for them to remain so over the duration of their interaction.

Also note that even if they are near each other, due to the small screen sizes of most portable devices, each person is typically only able to see his or her own screen. The ability to easily tell what the other is watching, and to synchronise to that other page can be useful.

Note that when Bob scans the barcode from Jane's device, he is physically near her. When the site gets the decoded URL from Bob's device, it can use this information to optimise the downloading of the page to his device. Imagine that the page on Jane's device is pulling in data from various locations on the network. If some of this data is coming from a node in a Content Distribution Network (CDN) close to Jane, then the site perhaps in conjunction with other sites in the CDN, could also use the decisions made about which nodes distribute to Jane's device, to also distribute from those nodes to Bob's device. Rather than having to go through and redo whatever calculations were made prior to servicing Jane's device.

The method of this section was primarily for a two person interaction. But Jane might communicate her URL to several others, as briefly discussed. In this group, she might have a privileged position in terms of her abilities to interact with the others, or to control how they can interact with each other. For example; she might permit them to also see which pages others are viewing on the site. Also, a member of the group might be able to follow the activities of a few others in the group.

4.5: Two Users Controlling an External Screen

This section describes how two users with mobile devices can jointly control an external screen. This differs from submission “1”, which described the screen showing a barcode which is scanned by the users.

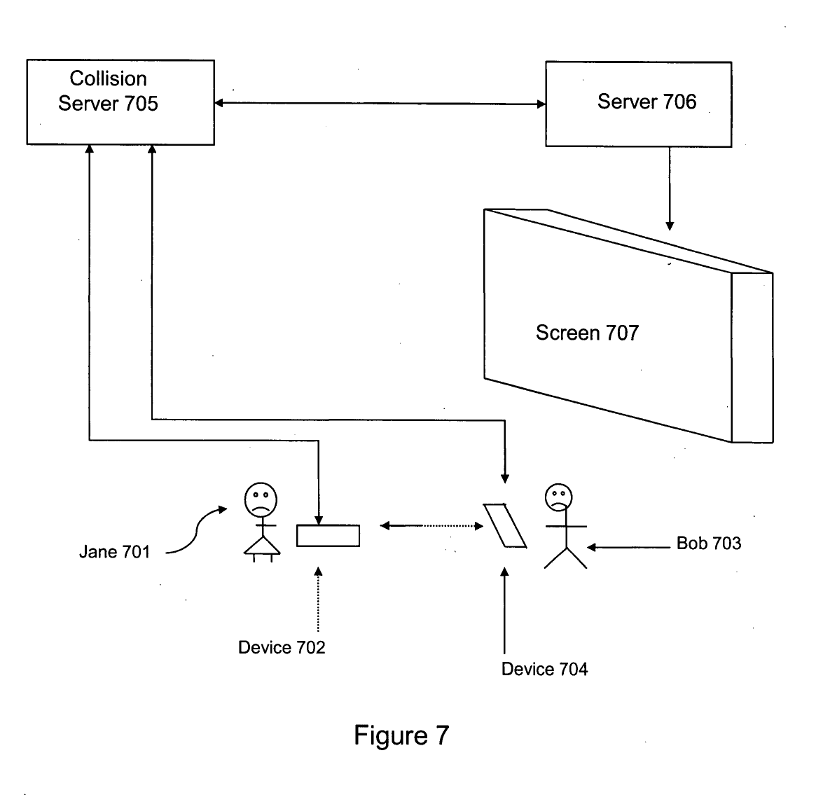

Consider FIG. 7. Jane 701 has mobile device 702. Bob 703 has mobile device 704. Jane and Bob are near each other. They are also near an external screen 707. The screen is controlled by server 706, which is on an electronic network, which we take to be the Internet. Also on the network is a collision server 705. Note that server 706 might not be near screen 707. Implicitly (i.e. not shown in FIG. 7), screen 707 might be controlled by a nearby computer which is on the network. That computer gets control signals from server 706 to tell it what to show on screen 707.

Server 706 wants to let 2 or more users jointly control screen 707 with their mobile devices. In general, the users cannot touch screen 707. Screen 707 is considered to be in a fixed location, at least during the time interval under consideration.

At some earlier time, before Jane and Bob arrive near screen 707, Server 706 sends the location of screen 707 to the collision server. Optionally, server 706 might also send a short label of the screen. This label might also appear on the screen image, or as a hardcopy printed label near the screen. The label can be text or graphics. Screen 707 might show a message telling users that they can control it by colliding their mobile devices.

In general, the users might need to pre-install some software on their devices, that is associated with the collision server, as discussed earlier. And the users might need to set appropriate permissions on their devices, to let the collision server detect the appropriate colliding devices. We assume this has been done by Jane and Bob. Either before they are at their present location, or there, prior to the next steps.

There might now be an option on the client collision software on one or both of devices 702 and 704 that lets its user pick the option of “control a screen”. Just one of the users needs to pick this option.

Jane and Bob collide their devices. The bidirectional arrow between devices 702 and 704 is meant to indicate this collision. Various data from the devices is then uploaded to the collision server 705. The latter is then assumed to now correctly identify the devices 702 and 704 as being associated. It finds their locations. It also knows that they want to control a screen. It finds the closest screen to them.

If there are several such screens, it might download to one or both of 702 and 704 a list of the screens, letting the users pick a screen. This list might be ordered in terms of increasing distance from them. The server might have a heuristic to limit the length of this list. For example, depending on the accuracy with which it knows the locations of the user devices, it might not show any screens more than say 100 meters away. Reducing the size of the list downloaded limits the wireless bandwidth required, making the process more robust. Also, a shorter list reduces the cognitive load on the users. Fewer choices can be a good thing.

The list might also show any labels associated with each screen, to aid the users in picking the desired screen.

Jane or Bob pick a screen from the list. The collision server might have a policy to handle what it does if 2 different picks are made. To this ends, and also to reduce overall bandwidth, one alternative is for the collision server to only download the list to one device.

The collision server sends the electronic addresses of the user devices to server 706, along with the label (or some other id) of screen 707. The latter data is needed when server 706 controls several screens. So that server 706 knows which particular screen to allocate to these users.

Server 706 uses the addresses to send control pages to the user devices. And it changes screen 707 to tell the users that they now control it.

We said “electronic addresses”. If both users are using client software (an “app”) from the collision server, we assume that this software will enable the showing of control pages from server 706 within it. Or perhaps the software will start up a browser in each mobile device, to which server 706 will update.

From the standpoint of the owner of the collision server, the method of this section lets it define a value added service, beyond the mere transferring of data between 2 users. In general, the owner of the collision server will be different from the owner of server 706. There can be expected to be many of the latter owners; each owning one or more screens in publicly accessible places. This lets the owners allow their screens to be used for varied purposes. Like multiplayer games. Thus the collision server can levy fees upon the owners instead of the end users. The fee can be a function of the amount of times users use the collision server to pick a given screen. It can also be a function of the length of engagement of the users with the screen.

If there are several servers, each controlling one or more screens, then the list of nearest screens can be expected to have screens from different servers.

In submission “5”, we described how a large screen might be divided into “split screens”. One user gets control of one split screen and another user gets control of another split screen. There, the control was initiated through the large screen showing barcodes, and the users scanning the barcodes with their devices. In the current submission, imagine that screen 707 is being entirely controlled by another pair of users (not Jane or Bob). Now suppose that the screen shows a message saying that other pairs could also control a portion of the screen. Or the screen might have speakers playing audio with this message. The message, where in video or audio, might tell another pair to collide their devices.

Jane and Bob do so, as described above. Server 706 then splits screen 707 into say a left half and a right half. The first pair of users now get control of the left half, while Jane and Bob get control of the right half.

Another extension of the collision server's ability is possible. Suppose there is just Jane standing in front of screen 707. She runs the client software of the collision server on her device. She picks the ‘control a screen’ option and uploads her device's location to the collision server. The latter can then send her a list of screens closest to her. She picks one and gets sole control of it, by a simple modification of the above steps.

This can be combined with the split screens. So screen 707 might initially be controlled by one user, using the method of the previous paragraph. Then Jane and Bob come along and collide their devices. Screen 707 splits into a left half and a right half. The first user gets sole control of the left half, while Jane and Bob get control of the right half.

Above, we discussed 2 users controlling a screen. There could be more than 2 users. One implementation is for 2 users to do the above steps to gain control. Then, one or each of those 2 can then collide their devices with the remaining users. This tells the collision server the addresses of the latter users, and it passes these onto server 706.

The method of this section can also be applied to letting the users communicate with each other via “chirps” to control an external screen, as per submission “7”.

4.6: Dynamic Group Purchases and Large Screen

In submission “6” we described the use of a large screen for dynamic group purchases, where the user interacted with the screen via scanning a barcode on it. In addition, the implementation of the screen and its controlling computer might let the user approach the screen or an associated device (which is connected to the computer) and collide her mobile device with it. Where a collision server is then used to associate the screen and its computer with the mobile device.

We add that this is expected to be of lesser use compared to users of mobile devices colliding those devices. In a movie theatre, for example as described in submission “6”, suppose a patron is already sitting down in the middle of a row of seats, with people between her and the aisle. It is inconvenient for her to get up and go to the aisle and then to the screen and collide her device with it.

Likewise in a crowd on a pavement near an electronic screen on a flatbed truck, it can be awkward for a person to go to it, to collide her device with it, compared to scanning a barcode on the screen from a more distant location.

4.7: Head Mounted Device and Smartwatch

HMDs have been used for several years. Recently with the advent of Google Corp.'s Google Glass™, Recon Instruments Corp.'s Jet, Meta Corp.'s SpaceGlasses and Vuzix Corp′.s M100 devices, advances have been made in usability. In this section we discuss the use of an HMD with the following properties. First, it can wirelessly contact at least one electronic network, which we take to be the Internet as the main case: It might also be able to contact a phone network. And often, if it can contact the Internet, this might be via the phone network.

Second, the user controls the choice of a web page (i.e. the user can go to an URL) and pick selectable widgets within a page (where this picking would cause a signal to the server).

Third, the HMD has a camera, controlled by the user. Though there could be a mode of camera usage where the camera periodically and automatically takes photos.

How the user controls the camera and web page depends on the HMD. It could have voice recognition (like Google Glass). It could have gesture recognition, where the user moves her hands in front of the camera. It could have a secondary panel or screen where the user can touch or type buttons (physical or virtual). It might have accelerometers, compass and gyroscope to detect if the user moves the HMD in particular ways (akin to the Nintendo Corp.'s Wii™). Or there could be other means. These cases are not meant to be mutually exclusive. A given HMD might permit several such means.

Let Alpha be the controls of the HMD that are accessible to its user, Jane. Let Alpha′ (“Alpha Prime”) be the controls accessible to a remote user, Bob. Alpha′ is made possible by the HMD wireless networking ability. There are 3 possibilities—Alpha=Alpha′, Alpha>Alpha′ and Alpha<Alpha′.

Alpha=Alpha′ means that the set of controls available to Bob is the same as those for Jane. This might be the hardwired default case when Jane gets the HMD. Or the operating system of the HMD lets Jane define which controls can be exported and she exports all of them.

Alpha>Alpha′ means that the set of controls available to Bob is a subset of those available to Jane. We might expect that this will be the most common case. As Jane decides to retain some commands solely for her. This can be analogous to unix computers having a user account and a root account. Where the root account is for administrative purposes. And Jane has the root set of controls, while a user set of controls is exported to Bob.

Alpha<Alpha′ means that the set of controls available to Bob is more than those available to Jane. This can be expected to be a rare case. One possibility is that the manufacturer or the owner of the HMD (where here the owner is not Jane) wants to keep the root set of controls accessible remotely, while Jane only has a user set of controls. One example might be where the HMD is rented to users like Jane, and the owner wants to retain some exclusive access to data, like the HMD's location, to enable the HMD's return.

In the case above of a remote root, there could still also be a remote user account. For applications where Jane can interact with regular remote users.

We could also have the case of Alpha′ (root)>Alpha>=Alpha′ (user), where Alpha′ (user) means the set of remote controls available to a regular remote user and Alpha′ (root) is the set of remote controls available to a remote root.

The reader should keep in mind that the use above of the greater than sign (′>′) or the greater than or equals sign (′>=′) is meant as symbolic. It might not necessarily have a valid numerical meaning. For example, suppose the full set of controls is the commands {A, B, C, D, E}, which is available to root. It restricts Jane to {A, B} and a remote regular user to {C, D, E}. A simple count of the available commands suggests that Alpha′ (user)>Alpha. But if commands A and B are more important in the running of the HMD and C, D and E are relatively minor or infrequently used commands, then Jane generally has more control of the HMD than Bob.

For the HMD camera, the controls available to either Jane or a remote user can vary depending on the functionality of the camera. At the simplest level, the camera has a button to take a photo. Perhaps at regular intervals. Like providing a video feed. Another control could be to vary to resolution of the image. If the camera could be used to both still images and for video, then the taking of a still image might be at a higher resolution.

The camera could also have one or more of the Pan, Tilt and Zoom (PTZ) controls. Note that implementing these will likely add to the weight and power consumption of the HMD. Since these might involve mechanical gears etc. So unlike say a fixed security camera on the side of a building, PTZ has a real cost to the HMD user.

The camera could also have controls for filtering. These might control the spectral range. Or for spatial filtering.

The HMD might also have other sensors with associated controls.

An HMD can be used in the manner of submission “1” to control a external digital screen, where the latter screen is connected to a computer that is connected to the Internet. That digital screen is not part of the HMD. Typically, it might be in a shop window, and the user wearing the HMD is a pedestrian standing on the pavement in front of the shop window. See FIG. 1 of submission “1”. While the label in that FIG. 1 refers to a cellphone, the text of submission “1” says, in part, “One extension is that instead of a cellphone, Jane might have another portable device that has a camera and software to decode a barcode into a URL.” This portable device might be an HMD.

Let Beta be the set of controls of an external device available to the HMD user. The main example of an external device is the external digital screen. Let Beta′ (“Beta Prime”) be the set of controls accessible to a remote user. We have 3 cases—Beta=Beta′, Beta>Beta′ and Beta<Beta′: The discussion below relates to these cases.

The reader should keep in mind the distinction between the controls relating to Alpha and Alpha′ and the controls relating to Beta and Beta′. In part, this notation is used to avoid any confusion.

The latter set of controls can be expected to be viewed in a web page, either by the local or remote user. The controls of Alpha have no connection to web pages. But in practice, for Alpha′, how these controls are viewed by the remote user might be as a web page.

The HMD needs access to software that can decode an image of a barcode. And, if the decoded data is an URL, the software brings up a browser on the HMD screen and loads it with that URL. The browser goes over the network to load the page referenced by the URL. The software might be physically present on the HMD or accessed over the network.

User comments in 2013 on the Google Glass suggest one aspect that might be common across many types of HMDs, current and future. Sustained reading of large sections of text or images on the display might be tiresome or just awkward. For the Google Glass, this is in part because the current design has the display mounted above the frontal direction of the user. So the user has to glance upwards to read it.

But this also suggests an advantage of submission “1” as applied to an HMD controlling a screen. The web page on the HMD display can be minimal in text and graphics. It shows a simple set of controls for the user to control what appears on the big external screen. The user is intended to spend most of her time looking at the contents of the latter, and only occasionally look at the web page and make commands to pick a selectable widget in it.

These remarks also pertain to a user controlling a screen with a cellphone. But an HMD can be expected to have a smaller display and a more minimal set of controls. Thus we suggest that submission “1” and the current submission are even more relevant to an instantiation using HMDs than cellphones.

Smartwatches are devices worn on the arm that function as watches with extra capabilities. Suppose a smartwatch has wireless network access, and we take the network to be the Internet. The screen of the smartwatch could show a web page, and there would be some means for the user to click links and buttons in the page. Now suppose the smartwatch also has a camera. Then, as with the HMD, a smartwatch can be used to control a large screen in the manner of submission “1” and this submission.

For both an HMD and a smartwatch, one example of a minimal set of controls on a web page to be shown on the device display is as follows. The large screen shows a series of pages, like the pages in a hardcopy book. The control page essentially needs just a next page button, a previous page button and an exit button, for a total of three buttons. (More could be envisioned of course.) Thus a 3 button control web page would be easy for the user to quickly understand and use, while letting her retain most of her attention on the large screen.

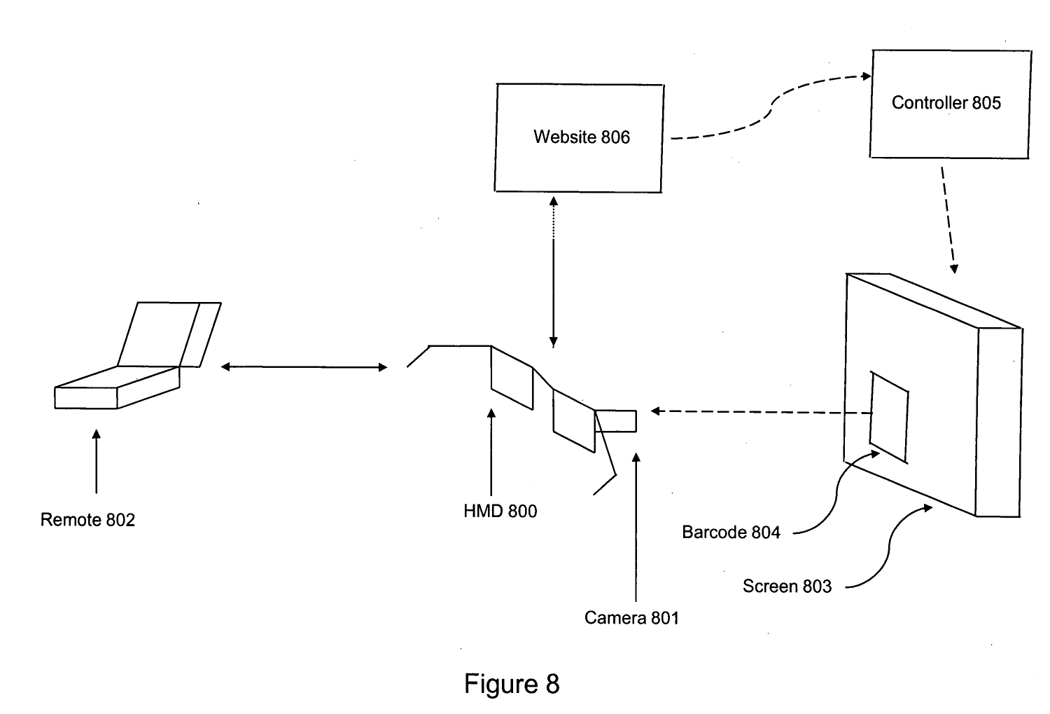

FIG. 8 shows an HMD 800 controlling a nearby Screen 803 via the scanning of a barcode 804, using Camera 801. It shows the HMD interacting wirelessly with a Remote 802 device. Remote 802 is operated by Bob, while HMD 800 is operated by Jane. Remote 802 is an electronic device with a screen. It might be a personal computer, laptop or cellphone, or other types. Note that Bob and Remote 802 in general will not be in line of sight of Jane or Screen 803. This is one difference compared to submissions “1” and “5” where multiple users were required to be in line of sight of the large shop screen or electronic billboard.

When HMD 800 scans the barcode, it decodes the barcode and, assuming that the barcode wraps an URL, it brings up a browser and loads it with the URL. (The browser is visible in some manner to Jane.) This causes the browser to contact Website 806, to which the URL is referring. Website 806 contacts Controller 805 which then alters the contents of Screen 803 in some manner. The reader should recognise that the feedback loop between Screen 803, HMD 800, Website 806 and Controller 805 was described in submission “1”.

What is new is the possibilities offered by the HMD being able to contact a remote machine, different from the screen and controller with the barcode.

First, Jane can show Bob a series of still images or a video feed from her HMD. This can start before she scans the barcode or after, once she has control of Screen 803. But the main usage is expected to be the latter, where she spends some time changing or searching what appears on Screen 803. The point is to involve Bob to some degree in her interaction and control of Screen 803.

As a practical matter, the wireless bandwidth between her HMD and Bob's Remote 802 might necessitate the sending of a smaller signal than what she is capturing. A smaller frame rate, for example. Or a downgrading of the resolution of images.

The use of her HMD to provide a remote visual feed can be easier than doing so with a cellphone camera. For a prolonged capture of her interaction with the screen, it is harder for her to hold a phone camera up to scan Screen 803 and also use the controls on her phone web page to change Screen 803. Especially if her phone display and camera are on the same side of the phone.

More importantly, it is harder for her simply to continuously hold up her phone to take in the image of Screen 803. It is inherently easier with an HMD, since that rests on her head.

Jane could also supplement the video with text or audio comments. The text might be typed by her on the HMD, if this is possible and convenient. The HMD then sends this to Remote 802.

The audio could be of 2 types. One is any audio that appears on her web page display from Website 806. The HMD could forward this to Bob's device. A straightforward relaying. Another type of audio is what Jane says into the HMD. This is sent to Bob's device. The HMD might send both types, or it lets Jane restrict by preventing the downloaded audio from being forwarded.

The text or audio by Jane might be to inform Bob about her opinions of what Screen 803 is showing. And also to ask his opinions.

In the wireless connection between her HMD and Remote 802, Bob can give feedback to her. This could be by audio to her HMD. Assuming that his Remote 802 can take audio input and that her HMD can play audio.

The feedback might be text. Bob types this into an appropriate place on his computer and the text is sent wirelessly to HMD 800, where it appears on the HMD display.

A variant is where Bob types his feedback, but the HMD gets this text and uses a Text To Speech program to convert it to audio, which it then plays for Jane. Note that this conserves the bandwidth from Bob to Jane, since text is a smaller signal than audio.

The feedback by Bob can be a commentary on what he sees on Screen 803 and also advice to Jane about what that screen should show. Jane can use the advice to decide what actions to take on the web page of controls that appears on her HMD display.

In general, Jane might export video to several remote users. If there are 2 users, and they can give audio feedback, and Jane's HMD has stereo speakers, she might send audio from one user to her left speaker and audio from the other user to her right speaker.

For simplicity, FIG. 8 only shows one remote user. There can be multiple remote users. There might be an optional multicast method that lets Jane's HMD serve those remote devices in some efficient bandwidth minimising manner. This could involve some intermediate machine between the HMD and the remote devices. Or perhaps one remote device acts to relay its feed from the HMD to other remote devices.

Going back to the case of one remote user, Bob; he can also offer programmatic feedback. There can be an app installed on HMD 800 and Remote 802 that lets Bob also see and control the web page that appears on HMD 800 from Website 806. In addition to Bob seeing the image feed from Camera 801.

Thus after from initiating the feedback loop by scanning the barcode, Jane essentially acts in a passive manner. Bob then remotely controls Screen 803, in a greater sense than Jane having remote control of that screen. He is twice removed from the screen.

We say an app on both devices, for simplicity. In practice, this could be 2 apps that interact according to some published software Application Programmer Interface [API]. The app on the HMD could be a server-type app, while the app on Bob's device could be a client-type app.

One variant is where the app on the HMD lets Jane restrict what type of buttons or links Bob can access in his version of her web page. The app on HMD 800 might make the equivalent of a new web page, that only has elements he can access and pick, and then exports this to Remote 802. This simplifies his decision logic, albeit by restricting it, and thus reduces the cognitive load on him.

Consider again the case of the HMD serving data to several remote user machines. Suppose the control page from Website 806 offers several choices. The app can let the remote users vote on their preferences for what to pick or type. This echoes what was written on submission “1” about several users in front of a large screen showing a barcode being able to vote on choices of what the screen would show. But now, the users are not in line of sight of the screen.

Jane might also have just a vote, same as any other single remote user. But given that it is her HMD that controls Screen 803, she might have a veto. The majority choices made by the remote users could be presented to her as a web page with these choices made, on the HMD display. So she could simply do 1 click and have these uploaded to Website 806, which then changes its big screen. Or she could override and alter one or more choices and then upload.

Thus far we discussed the scenario of Jane having one or more remote users ‘surfing’ on her HMD video feed mostly when she has already scanned Barcode 804.

But we can also look at the situation prior to her going to Screen 803. Suppose her HMD has geolocation data for its position as a function of time, and it uploads these along with the video feed to remote users. Those users, or some subset of them, might download possible routes to her HMD. These might be in terms of informal directions, like “walk left at the next light”, or in more formal latlong (latitude and longitude) coordinates. If the latter, her device might have code that converts these to directions that she can understand. Such navigation code is already well defined for cars.

In part, the users might steer her towards various desired objectives. One type could be shop windows with screens showing barcodes that give control of the screens. Or electronic billboards offering the same control mechanism. The locations of those screens might be available in some database and accessible via a Web Service or website. Bob's machine could access this and use Jane's current location to devise a route between her and the nearest suitable screen.

Or Jane might be a tour guide, with knowledge of the area she is traversing. She might let her remote users steer her around, to places they find interesting. A customised tour.

Above, we described how Jane and her HMD can decode a barcode on an external screen and then control it, as per submission “1”. And how the HMD can pass video of the external screen and a copy (entire or modified) of the controlling web page that the HMD gets from the server, to Bob's machine. An alternative is where the HMD decodes the barcode into an URL, but does not load its browser with the URL. Instead, it sends the URL to Bob's machine, which then brings up a browser and loads it with the URL. This can give rise to Bob's machine controlling the screen, while not in line of sight.

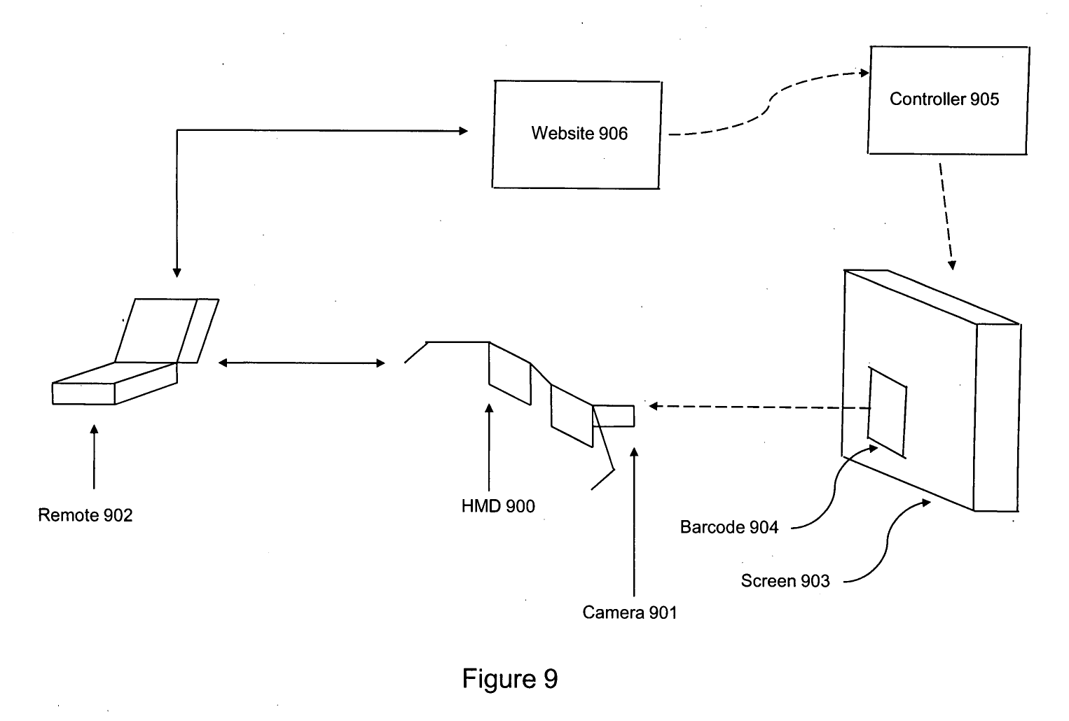

See FIG. 9. HMD 900 corresponds to HMD 800 in FIG. 8. Camera 901 corresponds to Camera 801, etc. The only difference between the figures is that instead of HMD 800 contacting the Website 806, Remote 902 contacts Website 906.

Suppose the page on Screen 903 requires that the user enter a username and password on the web page he gets from the server. In FIG. 9, Bob can do this on his Remote 902. and upload these to Website 906, without the information ever passing through the HMD, encrypted or not.

In our earlier submissions, a machine and its user not in line of sight of a screen and controlling it was seen as undesirable. Because it allowed the case where, for example, a user in line of sight gets control and walks away while retaining control. Either deliberately or not, this ties up the screen and can prevent others near it from controlling it. The point is that the (large) screen is valuable real estate that is meant to be best used when controlled by people nearby.

But in this submission, if Jane's HMD passes video of the screen to Bob's machine, then he can see the screen and the changes he makes caused by his actions on his web page. Suppose the server finds the coordinates of Bob's machine. The server might have a policy that this scenario is desirable (or at least permissible), while the situation of the previous paragraph is not. To distinguish between the two, the server might put a visual marker on the screen, and then on the web page it sends to Bob's machine, it asks a question about the marker. If Bob answers correctly, it suggests that he is getting a video feed of the screen's image, sent to him by some intermediate device within line of sight. While if Bob answers wrongly, the server might remove his control of the screen. (The server could ask him a second question, to give him another chance at answering correctly.)

Analogous to the Captcha™ tests that are used to (try to) detect robot programs (usually “spiders”) that might be loading a web page. A difference is that in this submission the point is whether the remote entity (Bob or even a robot) can see an image of the screen. Thus the test can be much simpler than say trying to decipher deliberately distorted text.

FIGS. 8 and 9 also lead to a split screen variant. In submission “5” we described how two users near a shop screen could get joint control of the screen. The screen divides into left and right parts and one user controls the left and the other controls the right. In the current submission, consider FIG. 9. When HMD 900 decodes the barcode into an URL, it passes the URL to Remote 902, which then uses it to access Website 906. But now HMD 900 also does this. So FIG. 9 would be altered to add a bidirectional arrow between HMD 900 and Website 906.

Website 906 might have a policy that if it gets two accesses with the same URL within some time interval, then this is either two users in line of sight of Screen 903 scanning the same Barcode 904 or the situation in the previous paragraph. And that this is permissible for splitting Screen 903. Hence FIG. 9 is combined with FIG. 9.

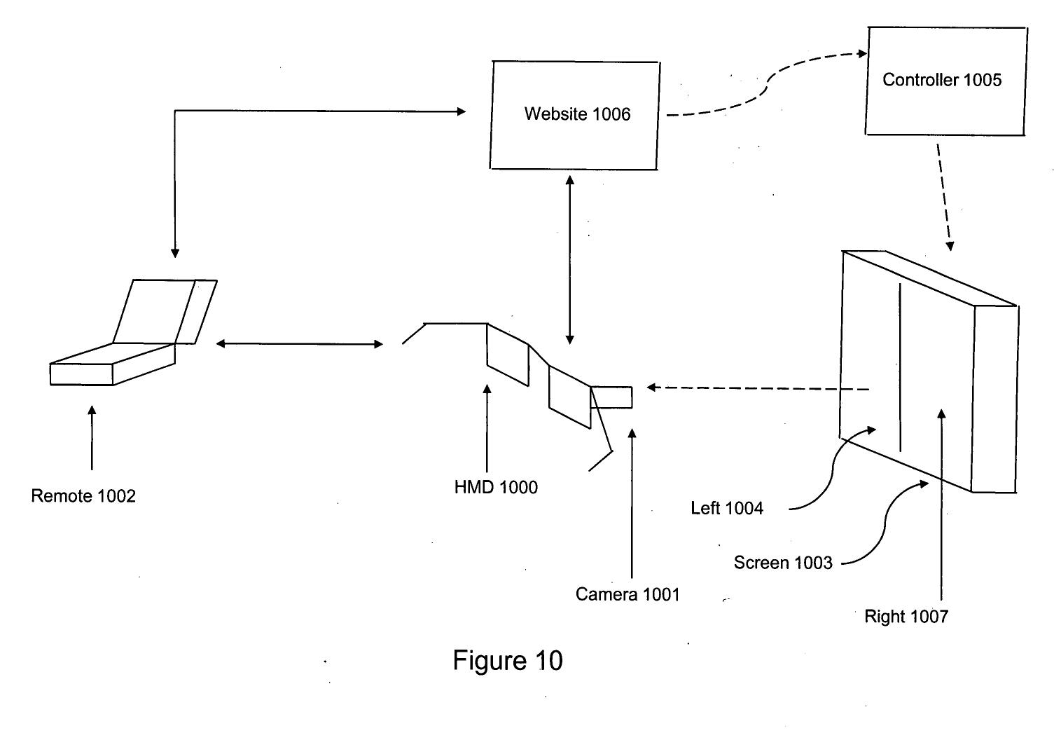

We now have FIG. 10. Screen 1003 is split into 2 parts. Jane with HMD 1000 controls one part, Left 1004, and Bob with Remote 1002 controls the other part, Right 1007. Jane uses Camera 1001 to give him a video feed so that he can see Screen 1003 or, presumably, at least his part.

Another use is Bob playing a multiplayer game against someone in line of sight of the screen. That person might or might not be Jane.

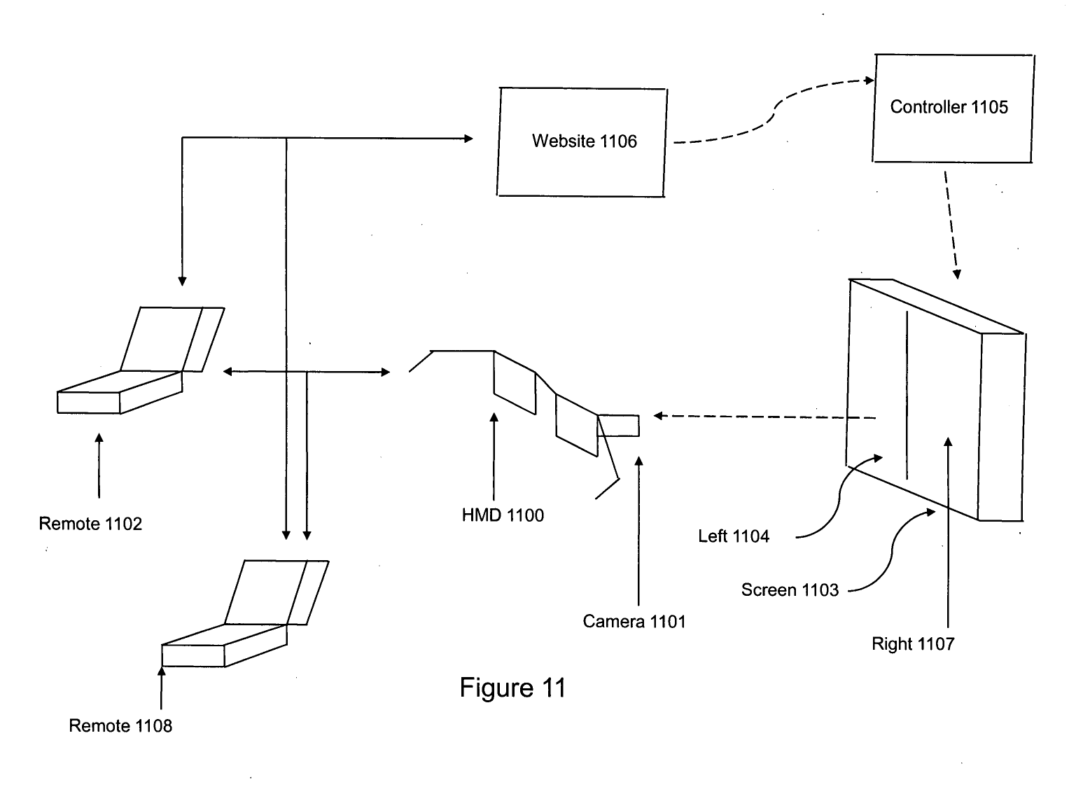

Another use is Bob and another person, Mike, where both are not in line of sight and both are being served video by Jane's HMD. Each gets a split screen, as in FIG. 11. So each has separate independent control of a section of Screen 1103. Mike controls the device Remote 1108.

FIG. 11 shows that HMD 1100 does not make a direct contact with Website 1106. Instead, Remote 1102 and Remote 1108 separately make direct contacts with Website 1106. Bob's Remote 1102 might be considered as controlling Right 1107 while Mike's Remote 1108 controls Left 1104.

A variant on FIG. 11 is where the two remote users jointly play a game on Screen 1103. So there are no separate Left 1104 and Right 1107. Rather, they each have access to the same game playing area of Screen 1103.

A variant on FIG. 11 is where the HMD 1100 also contacts Website 1106. This might be because Jane wants to also control a split screen of Screen 1103 or because she wants to take part in a game with one or more of the remote users.

In both cases (split screen or multiplayer game) Screen 1103 might have an audience both local (in front of the screen) and remote. Where the remote audience is being sent video by Jane's HMD.

If the game of Screen 1103 can be played by more than 2 players, then the 2 remote users, Bob and Mike, might be playing against other remote or local players.

If Bob has remote control of a split screen, then Jane's HMD could use graphical control of its view of the entire large screen to isolate Bob's split screen and only transmit this to Bob's machine, to reduce bandwidth use.

Now consider a remote user, Bob, having either control of a split screen or playing a game on the large screen. The server can give him an option, perhaps exercisable via a page on his device, that lets him see the large screen display (or an appropriate subset like his split screen) directly on his device screen. The server would be essentially simulcasting. This could depend on whether his device can usefully show the large screen (or his portion if he has a split screen). If he has a mobile device with a small screen, this might not be appropriate and the server might have logic to offer Bob this choice.

But suppose that Bob gets to see the large screen [or his portion] directly on his device. In FIGS. 8-11, this decouples him from depending on the HMD for the video. If the HMD is not serving any other remote users, then Jane could walk away from the large screen and let Bob (or other remote users) keep interacting with the large screen.

The remarks of this section involved imaging of a barcode on a large screen. They also pertain to when the screen has an associated speaker that transmits an audio signal encoding an URL, as per submission “7”. Here, the HMD would have software and hardware that could decode the audio and extract an URL. Note that it is still assumed that the HMD uses its camera to transmit images of the screen to the remote user Bob.

The remarks also pertain somewhat to when the user can collide her HMD against the large screen, or an associated device.

If an HMD has two cameras other possibilities arise. One is where the cameras can be independently controlled. This can allow the case of 2 remote users having separate control of a camera. Further, if the controls allow zooming, then for the case of a split screen of an external screen, one remote user can use the left camera to see an image just of the left split screen and the other user uses the right camera to see just the right split screen.

4.8: Joining an Existing Social Network

Consider a user Jane, who is a member of a social network. She meets Bob in person. Both have mobile devices. He is not in her network of “friends”, where the latter is a set of associates on the social network. Suppose also that they do not have each other's email addresses or phone numbers. After talking with him, she decides to invite him to be a friend. For most social networks, this is currently done by Jane giving him in some manner her home directory on the network. Essentially, she needs to give him the URL of that home directory. To transfer this information to Bob, she might say the URL aloud, or she shows it on her device. Bob then transcribes from sound or sight the URL and types it onto his device.

Or, Bob says his email address, or shows it to Jane on his device. Jane then writes this onto her device and sends the URL in an email to his address.

To minimise the combined manual effect, one answer is for Jane to convert her URL into an encoded form and then transfer the encoded form. This can be a barcode or sound or via collision, as described earlier in this submission or in submission “8”.

Now suppose that her home page is not publicly viewable. Only her friends can see it. They might have to furnish a password to the social network before it releases the page to them. Or the social network might require them to access it from a pre-defined set of addresses. Or other means. The point is that Bob will not be able to do this a priori.

One solution is for Jane to go to a setup page on the social network. There is an option which lets her make a temporary URL. This might have an expiration date. This URL is encoded and then Bob gets it by scanning a barcode or decoding an audio from her device, or colliding his device with her device.

A variant is where the setup page lets Jane define a password or a pair of a question and an answer. This is made into a “challenge” page with an associated URL address. The URL is transmitted to Bob's device by the above means and decoded. Jane can verbally tell Bob the password or the question and answer. Bob can then at some future time display the challenge page. If he inputs the correct password or answer, he gets access to her home page.

The setup page might also let Jane define an expiration date.

Alternatively, Jane could go to a page on the server, that lets her make an URL that is meant to be decoded immediately (or within some short time interval) by Bob. When Bob does this and gets a decoded page, he has to answer some question or questions or perhaps also input some password. This URL has an identifier of Jane's device address. So a feedback loop is made, where Bob's progress in filling out his decoded page is sent to the server, which then updates Jane's page. This feedback takes advantage of the immediacy of the situation, where Jane and Bob are near each other.

Or instead of an immediate feedback, there could be a delayed feedback. In submissions “1”-“8”, largely the feedback was considered to be done as fast as the hardware and software could process the steps and transmit. But in the current case, the server might record Bob's progress. Then at some later time, when perhaps Jane logs into the server, it might tell her of this. Or the server could send some message to an electronic address of Jane's.

For both the immediate and delayed feedback, but perhaps more so for the latter, the feedback shown on Jane's device (or the message sent to her) could be several updates on her device, or several messages. Where these indicate changes that Bob made or is making on his device.

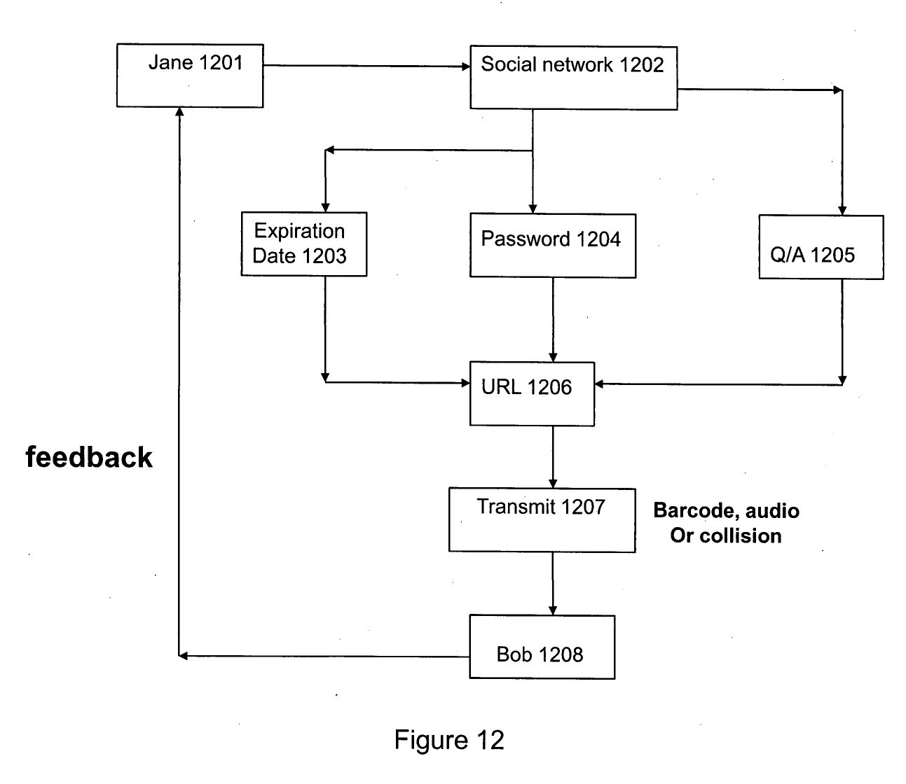

FIG. 12 shows Jane 1201 interacting with her device (not shown) at the social network 1202. This can generate for example item 1203, which is an expiration date, or item 1204, which is a password, or item 1205, which is a question and answer pair. This is used by the social network's server to make item 1206, an URL.

Item 1207 is the transmission mechanism, barcode, audio or collision, that conveys the URL to Bob's device 1208. The unnumbered label by item 1207 emphasises this key step.

The arrow from Bob 1208 to Jane 1201 designates the immediate or delayed feedback loop resulting from his actions when his device decodes URL 1206 from the transmission. The unnumbered label on this arrow emphasises the importance of the loop.

The setup procedure, if correctly done, can be less effort for Jane than having to transcribe Bob's electronic address. It also minimises Bob's manual steps.

4.9: Ad Hoc Social Network

The previous section described an existing social network. Now return to the case treated earlier in this submission, where Jane and Bob are in a collaborative interaction at some site, using their mobile devices. And where they are not linked in a social network. Earlier, they entered into the interaction via the methods of this submission. This section looks at how the site can define a simple social network. Or perhaps to add to an existing social network.

Suppose Jane and Bob interact for some time >x, where x is set by the site. Or it might be set by Jane. X is used as a parameter, so that if the interaction is longer than this, the site asks Jane if she wants to add Bob to a group of hers. Or the site might do this automatically. This group is held on the site. Depending on the site's policy, Bob might or might not be able to prevent Jane from adding him.

Also, Bob might have a similar ability to Jane, to add her to his group. The ‘x’ above that we referred to for adding Bob to Jane's group might be different from the ‘x’ that Bob can set, to add Jane to his group. These operations in general will be different. The ‘social network’ here is where Jane being in Bob's group does not mean that Bob is necessarily in Jane's group.

There could be other ways that the interaction between Bob and Jane might be quantified. So if the quantified amount is greater than some settable parameter y, then the site puts Bob into Jane's group. This amounts to saying that if the interaction between them is “meaningful”, then Jane is interested in having Bob in her group. Where meaningful is defined by the value of y.

One example might be a count of the number of text messages that Jane and Bob send to each other via the site. Since the site gets these, it can apply various measures to this corpus. A variant is the total length of those messages. Here, presumably, long messages suggest a more meaningful interaction.

Another example might be just the number of text messages that Jane sends to Bob. Or the total length of those messages.

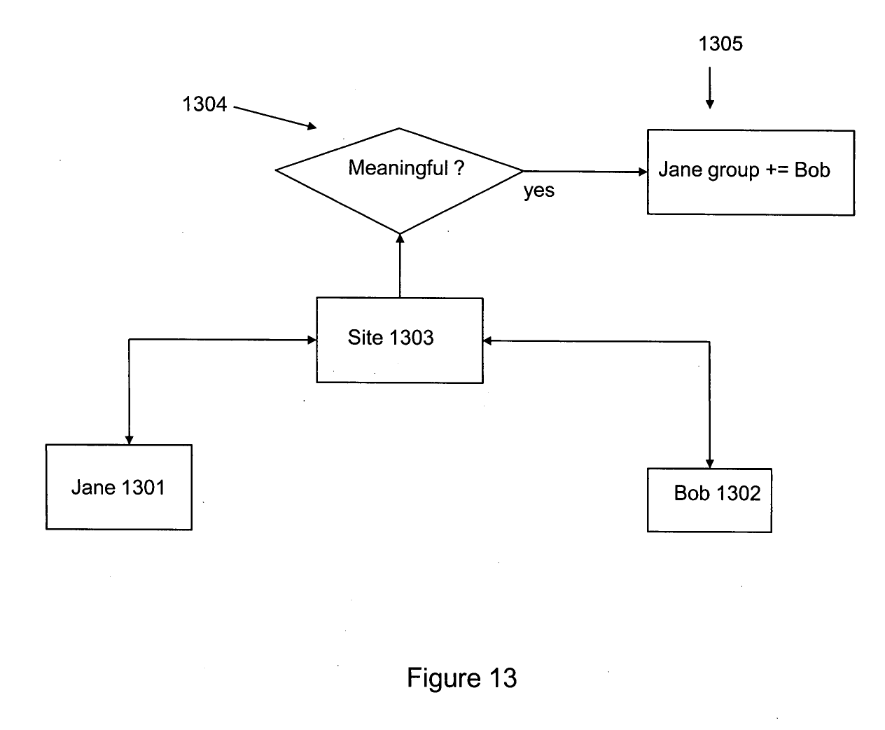

FIG. 13 is a schematic of Jane 1301 and Bob 1302 interacting at Site 1303. It is assumed that the interaction was initiated using the earlier methods of this submission. So for clarity the steps of the initiation are not shown here. Item 1304 is a test done by the computer of Site 1303. It asks if the interaction is “meaningful”, as defined by Jane. If so, Site 1303 does the action of item 1305. It adds Bob to a group owned by Jane. FIG. 13 is shown from Jane's perspective. A similar figure could be made for Bob.

The site might have a variety of these measures available. It could let Jane pick one or more of these to apply. By ‘more’ we suggest the following. The combination of measures might be in some Boolean form. So suppose the site has measures A, B and C. Each has a value of true or false depending on some formula. Then Jane could pick just one of these, or, say, A or (B and C).

Note that when Jane adds Bob to her group (if this is possible), she might have several groups defined at the site. For example, the site might have different multiuser applications, and she might define one group for each application that she uses.

Also for a given application, the site might aid Jane by letting her easily define one group. But she might be able to define several groups for this application.

She might also be able to define a group and add users to it that she has interacted with in different applications run by the site.

The site could do all necessary steps to get identifier information from Jane or Bob, if it does not already have this. They might be able to define nicknames specific to the site. Or the site might ask for various contact information about their accounts on an external social network. So that, for example, the site could use in a programmatic manner any contact information already on the external site.

By the site building its information on Bob, who might be a new user (player) on the site, it lets the site expand its user base.

The point is that when users interact in a multiuser application at the site, this defines an ad hoc group. There can be value in the site retaining this information. So for example, Jane in future can electronically contact other members of this group. She might then be able to interact with them in the same application or other applications, even if they are not in proximity.

When the site asks Bob (or Jane) to type in information about themselves, like their contact information on an external social network, this might be easier than the original task of, say, Bob having to type the URL of the page that Jane was on, to get into the same interaction application as her. It was the difficulty of typing the URL (i.e. transfer this across the “air gap” between the mobile devices) that is the motivation for using the mechanisms of this and earlier submissions.

For example, if the site asks for Bob's email address, the latter is likely to be shorter than many URLs. Also, Bob's device might have stored his email address and have software running that when Bob types the start of it into a text input widget, an auto-completion facility lets him easily complete the address with fewer keystrokes. Whereas this is not possible if Bob has to type an URL that he has never typed before.

The above discussed a group defined by activity on a given site. It is possible that Jane can define a group on her device, where the members have interacted with her on different sites. A member might have only interacted with her on one site. While another member only interacted with her on another site. Perhaps a third member interacted with her on two or more sites.

Jane could have a program on her device, or external to the device, but accessible by it, that lets her make this group. Where the contact information was extracted from the sites that she was on. There might be an appropriate Application Programmer Interface [API] supported by the sites, that lets her program (which in general will not be located on any of the sites) access the sites' group information.

We claim:

1. A system of a first user with a first device, a second user with a second device, a collision server and a server; where the user uses the first device to contact the server; where the server makes an Universal Resource Locator (URL) containing an identifier of an address of the first device; where the server sends the URL to the collision server; where the users collide their devices; where the collision server sends the URL to the second device; where the second device sends the URL to the server; where the server sends data to the devices to perform a multiuser application.

2. The method of claim 1, where the application is a game.

3. The method of claim 1, where the application is a collaborative workspace.

4. The method of claim 1; where the first device makes an URL encoding its address;
where the first device sends the URL to the collision server; where the users collide their devices; where the collision server sends the URL to the second device; where the second device sends the URL to the server; where the server decodes the URL to find the address of the first device; where the server sends data to the devices to perform a multiuser application.

5. The method of claim 4, where the application is a game.

6. The method of claim 4, where the application is a collaborative workspace.

7. The method of claim 1, where the server controls several screens; where the server sends locations of the screens to the collision server; where the users collide their devices; where the collision server finds the locations of the users; where the collision server sends to the first device a list of nearby screens; where the first user picks a screen; where the collision server sends to the server the addresses of the devices and an identifier of the screen; where the server sends pages to the devices; where selectable items on the pages let the users control the screen.

8. The method of claim 7, where the screen is initially controlled by a third user; where the first and second users collide their devices; where the server divides the screen into a first section and a second section; where control of the first section is given to the third user; where control of the second section is given to the first and second users.

9. A system of a mobile device with a camera, a computer showing a barcode on a screen; where the barcode encodes an URL; where the mobile device decodes the barcode; where the mobile device accesses a server of the URL; where the server sends images to the screen; where the server sends a page of controls for the screen to the mobile device; where the page has buttons that act as horizontal and vertical sliders; where the page has a button that acts as a return key; where the page has a button that acts as a tab key; where the page has a button that acts as a refresh button; where the page has a button that acts as a stop downloading button; where the page has a text input widget that acts as a text input field for the screen.

10. A system of a first user with a Head Mounted Device (HMD), a first computer showing a barcode on a screen, the barcode encoding an URL, a second user with a second computer; where a camera of the HMD sends images of the screen to the second computer; where the first user uses the HMD to decode the barcode; where the HMD accesses a server of the URL; where the server sends a page of controls to the HMD; where the first user selects items in the page; where the server changes the screen.

11. The method of claim 10, where the page plays an audio; where the HMD sends the audio to the second computer; where the second computer plays the audio.

12. The method of claim 10, where the HMD sends the page to the second computer; where the second user selects items in the page; where the selections are sent to the HMD; where the HMD sends the selections to the server; where the server changes the screen.

13. The method of claim 10, where the loading of the URL into a browser is done by the second computer; where the server sends a page of controls to the second computer; where the second user picks items in the page; where the server changes the screen.

14. The method of claim 10, where the HMD makes a second page of controls from the page of controls; where the controls in the second page are a subset of the controls in the page of controls; where the HMD sends the second page to the second computer.

15. The method of claim 10, where the first user types a text or speaks an audio into the HMD; where the HMD sends the text or audio to the second computer; where the second computer shows the text or plays the audio to the second user.

16. The method of claim 10, where the second user types text or speaks audio into the second computer; where the second computer sends the text or the audio to the HMD; where the HMD shows the text or plays the audio for the first user.

17. The method of claim 15, where text from the second user is received by the HMD and played as audio.

18. The method of claim 10, where the HMD sends images from its camera to two or more remote computers;

19. The method of claim 18, where the HMD sends a page of controls to two or more remote computers; where the HMD collects the choices of selected items from the remote users; where the most popular choices are sent to the server.

20. The method of claim 18, where the remote computers decode the barcode; where the remote computers contact the server; where the server returns pages; where selections made in the pages are sent to the server; where the server changes the screen.
